(19) United States
(12) Patent Application Publication
(10) Pub. No.: US 2025/0291724 A1
(43) Pub. Date: Sep. 18, 2025

(54) COMMUNICATION SYSTEM

(71) Applicant: Kioxia Corporation, Tokyo (JP)

(72) Inventors: Hirotaka HIGASHI, Kawasaki (JP); Shigeyuki UENO, Kawasaki (JP); Manabu WATANABE, Kawasaki (JP); Junji WADATSUMI, Tokyo (JP)

(73) Assignee: Kioxia Corporation, Tokyo (JP)

(21) Appl. No.: 18/982,791

(22) Filed: Dec. 16, 2024

(30) Foreign Application Priority Data
Mar. 18, 2024 (JP) 2024-042572

(51) Int. Cl. G06F 12/0802

(52) U.S. Cl. CPC G06F 12/0802; G06F 2212/60

(57) ABSTRACT

According to one embodiment, a communication system includes a host controller; communication devices; a cache device; and a path that couples the host controller and the cache device and couples the cache device and the communication devices in a ring shape, wherein the cache device includes: a first control circuit capable of data insertion and extraction into and from a frame from the host controller; a first transmission circuit transmitting a frame based on a processing result of the first control circuit to a communication device; a second control circuit capable of data insertion and extraction into and from a frame from a communication device; a second transmission circuit transmitting a frame based on a processing result by the second control circuit to the host controller.

### CROSS-REFERENCE TO RELATED APPLICATIONS

This application is based upon and claims the benefit of priority from Japanese Patent Application No. 2024-042572, filed Mar. 18, 2024, the entire contents of which are incorporated herein by reference.

### FIELD

Embodiments described herein relate generally to a communication system.

### BACKGROUND

There are known communication systems in which a host controller and a plurality of communication devices are coupled in a ring shape. In the ring-shaped connection, the plurality of communication devices is coupled in series. In such a communication system, it is desired that communication between the host controller and the plurality of communication devices is performed without delay.

### BRIEF DESCRIPTION OF THE DRAWINGS

FIG. 1 is a block diagram illustrating an example of an overall configuration of a communication system according to a first embodiment.

FIG. 2 is a block diagram illustrating an example of a host controller included in the communication system according to the first embodiment.

FIG. 3 is a block diagram illustrating an example of a communication device included in the communication system according to the first embodiment.

FIG. 4 is a block diagram illustrating an example of a cache device included in the communication system according to the first embodiment.

FIG. 5 is a diagram illustrating an example of a configuration of a cache memory in the communication system according to the first embodiment.

FIG. 6 is a diagram illustrating an example of a communication frame in the communication system according to the first embodiment.

FIG. 7 is a flowchart describing an example of operations of the communication device in the communication system according to the first embodiment.

FIG. 8 is a diagram illustrating a first operation example in the communication system according to the first embodiment.

FIG. 9 is a diagram illustrating a second operation example in the communication system according to the first embodiment.

FIG. 10 is a diagram illustrating a part of a third operation example in the communication system according to the first embodiment.

FIG. 11 is a diagram illustrating another part of the third operation example in the communication system according to the first embodiment.

FIG. 12 is a diagram illustrating a fourth operation example in the communication system according to the first embodiment.

FIG. 13 is a diagram illustrating a fifth operation example in the communication system according to the first embodiment.

FIG. 14 is a diagram illustrating a part of a sixth operation example in the communication system according to the first embodiment.

FIG. 15 is a diagram illustrating another part of the sixth operation example in the communication system according to the first embodiment.

FIG. 16 is a diagram illustrating a seventh operation example in the communication system according to the first embodiment.

FIG. 17 is a diagram illustrating an eighth operation example in the communication system according to the first embodiment.

FIG. 18 is a block diagram illustrating an example of a cache device included in a communication system according to a modification of the first embodiment.

FIG. 19 is a block diagram illustrating an overall configuration of a communication system according to a second embodiment.

FIG. 20 is a block diagram illustrating an example of a host controller included in the communication system according to the second embodiment.

FIG. 21 is a diagram illustrating a first operation example in the communication system according to the second embodiment.

FIG. 22 is a diagram illustrating a second operation example in the communication system according to the second embodiment.

FIG. 23 is a diagram illustrating a third operation example in the communication system according to the second embodiment.

FIG. 24 is a diagram illustrating a fourth operation example in the communication system according to the second embodiment.

### DETAILED DESCRIPTION

In general, according to one embodiment, a communication system includes a host controller; a plurality of communication devices; a cache device; and a communication path that couples the host controller and the cache device and couples the cache device and the communication devices in a ring shape, and is capable of transmitting a communication frame of a serial signal having a plurality of containers, wherein the cache device includes: a first reception circuit that receives a first communication frame from the host controller via the communication path; a first control circuit capable of data insertion and extraction into and from at least one of a plurality of containers included in the received first communication frame; a first transmission circuit that transmits a second communication frame based on a processing result of the first control circuit to a first communication device that is coupled to the cache device among the communication devices via the communication path; a second reception circuit that receives a third communication frame from a second communication device that is different from the first communication device among the communication devices and is coupled to the cache device via the communication path; a second control circuit capable of data insertion and extraction into and from at least one of a plurality of containers included in the received third communication frame; a second transmission circuit that transmits a fourth communication frame based on a processing result by the second control circuit to the host controller via the communication path; a memory configured to store data received from the second communication device by at least the third communication frame; and a controller that is coupled to the first control circuit and the second control circuit and controls the memory.

Hereinafter, embodiments will be described with reference to the drawings. In the following descriptions, the constituent elements with identical functions and configurations will be given a common reference sign. In addition, in the case of distinguishing a plurality of constituent elements with a common reference sign, a suffix is added to the common reference sign. In a case where a plurality of constituent elements does not need to be particularly distinguished, the plurality of constituent elements is given only a common reference sign without a suffix. The suffix includes a lower case alphabet, an index meaning an array, and the like, added to the end of the reference sign, for example.

### 1. First Embodiment

Hereinafter, a communication system according to a first embodiment will be described.

### 1.1 Configuration

A configuration of the communication system according to the first embodiment will be described.

### 1.1.1 Configuration of Communication System

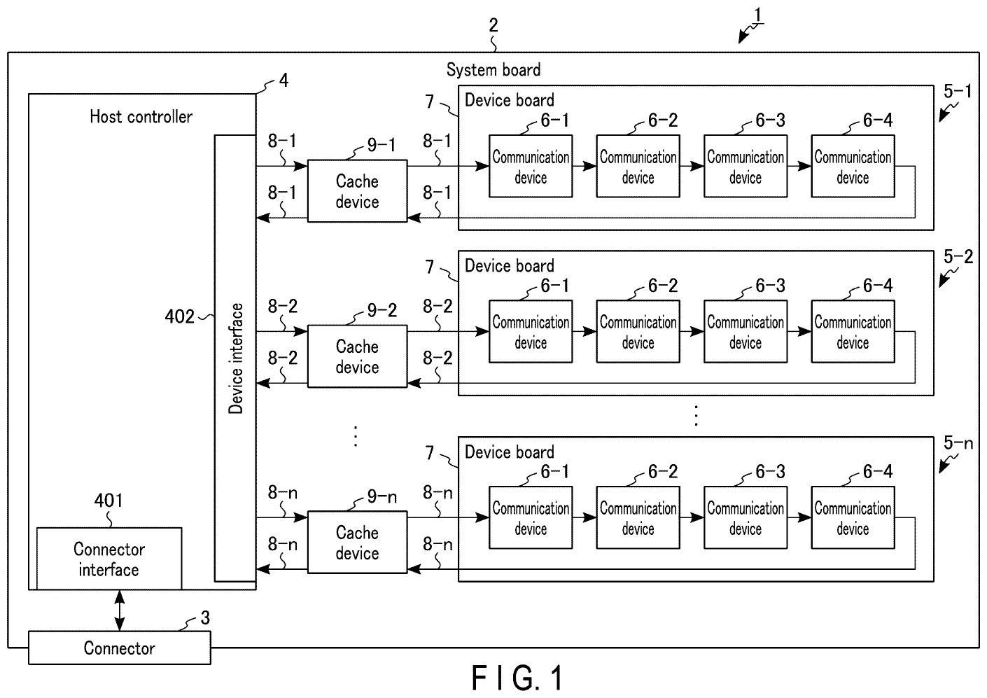

An example of a configuration of the communication system will be described with reference to FIG. 1. FIG. 1 is a block diagram illustrating an example of an overall configuration of the communication system according to the first embodiment.

A communication system 1 includes a system board 2, a connector 3, a host controller 4, a plurality of device boards 5, a plurality of communication paths 8, and a plurality of cache devices 9. In the example illustrated in FIG. 1, the communication system 1 includes n device boards 5-1 to 5-n. The value of n is an integer of 1 or greater. The communication system 1 also includes n communication paths 8-1 to 8-n respectively corresponding to the n device boards 5-1 to 5-n. The communication system 1 further includes n cache devices 9-1 to 9-n respectively corresponding to the n device boards 5-1 to 5-n.

The system board 2 is an accelerator board compatible with ultra-wide band and large capacity, for example. The ultra-wide band means that the bandwidth is 200 GB/s or more, for example. Provided on the system board 2 are the connector 3, the host controller 4, the plurality of device boards 5, the plurality of communication paths 8, and the plurality of cache devices 9, for example.

The connector 3 is used for connection between the system board 2 and an external apparatus such as a computer provided outside the communication system 1. The connector 3 couples the system board 2 and an external apparatus through a wired connection, for example. The connector 3 is coupled to the host controller 4.

The host controller 4 controls the entire communication system 1. The host controller 4 controls communication devices 6 mounted on the device boards 5. For example, if the communication devices 6 are memory devices, the host controller 4 requests or commands the communication devices 6 to perform a data read operation, a data write operation, a data erase operation, or the like. If the communication devices 6 are memory devices, the communication system 1 may also be called a memory system. The host controller 4 includes a connector interface 401 and a device interface 402. A more detailed configuration of the host controller 4 will be described later.

The connector interface 401 transmits and receives information to and from an external apparatus via the connector 3.

The device interface 402 transmits and receives information to and from the device boards 5 via the communication paths 8. The device interface 402 is configured to be capable of transmitting and receiving a differential serial signal, for example.

Each device board 5 includes a substrate 7 and the plurality of communication devices 6. In the example of the first embodiment, each device board 5 includes four communication devices 6-1 to 6-4. The communication devices 6-1 to 6-4 are mounted on the substrate 7 by soldering, a socket, or the like. The communication devices 6-1 to 6-4 are arranged side by side along the longitudinal direction of the substrate 7, for example.

Each communication device 6 is a device that operates based on communication with the host controller 4. In the following description, the communication device 6 is a memory device equipped with a NAND flash memory. The communication device 6 is a solid state drive (SSD) equipped with a NAND flash memory, for example. If the communication device 6 is a memory device, the device board 5 may also be called a memory array or a memory card. The communication device 6 is communicably coupled to the device interface 402 via the communication path 8. A more detailed configuration of the communication device 6 will be described later.

Each cache device 9 is a device that operates based on communication with the host controller 4. The cache device 9 is a device including a cache memory. Each cache device 9 is provided between any of the communication devices 6-1 to 6-4 corresponding to the cache device 9 and the host controller 4. The cache device 9 is communicably coupled to the device interface 402 via the communication path 8. A more detailed configuration of the cache device 9 will be described later.

Each communication path 8 is configured to enable transmission and reception of data between the device interface 402 and the cache device 9 corresponding to the communication path 8. Each communication path 8 couples the cache device 9 corresponding to the communication path 8 and any of the communication devices 6-1 to 6-4 corresponding to the communication path 8 through a ring connection. More specifically, each cache device 9 is configured to be capable of transmission and reception of information between the data output terminal of the device interface 402 and the data input terminal of the communication device 6-1. The input terminals and the output terminals of the communication devices 6-1 to 6-4 are coupled to the cache device 9 in a ring shape via the communication path 8. Each cache device 9 is configured to be capable of transmission and reception information between the data output terminal of the communication device 6-4 and the data input terminal of the device interface 402. Each communication path 8 can transmit a differential serial signal.

Each cache device 9 and the plurality of communication devices 6 corresponding to the cache device 9 transmit and receive a communication frame of a differential serial signal via the communication path 8. The communication frame is a unit (first unit) of data to be transmitted via the communication path 8. In each communication path 8, the communication frame output from the host controller 4 passes through the cache device 9, the communication device 6-1, the communication device 6-2, the communication device 6-3, and the communication device 6-4, for example. Then, the communication frame output from the communication device 6-4 is input to the host controller 4 via the cache device 9 again, for example. The communication frame has a plurality of containers, each of which may contain data. The container has a size smaller than that of the communication frame and is a unit (second unit) of data to be transmitted via the communication path 8. The configuration of the container will be described later. Each communication device 6 and the cache device 9 executes data insertion and extraction into and from the containers of the communication frame according to a particular condition. Data insertion/extraction includes writing data into the container (data insertion) and reading data from the container (data extraction).

The communication system 1 may have a configuration without the system board 2. The connector interface 401 may be directly coupled to an external apparatus without the connector 3. In addition, the system board 2 and the substrates 7 may be integrally formed.

In the following description, if it is not necessary to distinguish the host controller 4, the communication devices 6, and the cache devices 9 from one another, each of the host controller 4, the communication devices 6, and the cache devices 9 will also be simply called a device.

### 1.1.2 Configuration of Host Controller

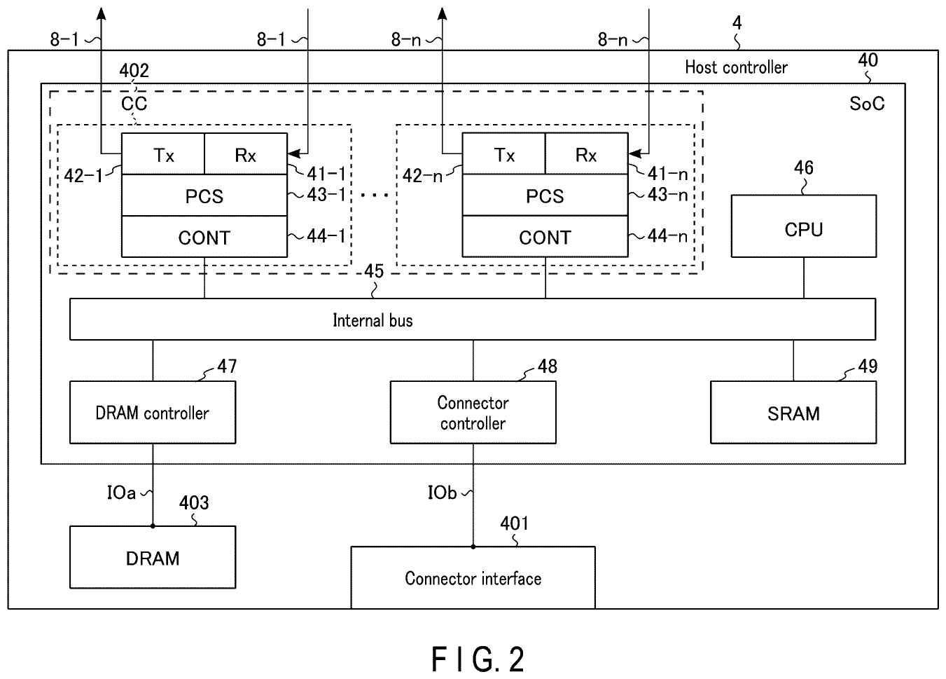

A configuration of the host controller 4 will be described with reference to FIG. 2. FIG. 2 is a block diagram illustrating an example of a host controller included in the communication system according to the first embodiment.

In addition to the connector interface 401 and the device interface 402, the host controller 4 further includes an internal bus 45, a central processing unit (CPU) 46, a DRAM controller 47, a connector controller 48, a static random access memory (SRAM) 49, and a dynamic random access memory (DRAM) 403.

The internal bus 45, the CPU 46, the DRAM controller 47, the connector controller 48, the SRAM 49, and the device interface 402 are included in a circuit 40. The circuit 40 is an integrated circuit such as a system-on-a-chip (SoC), for example. The CPU 46, the DRAM controller 47, the connector controller 48, the SRAM 49, and the device interface 402 are coupled to one another via an internal bus 45. The circuit 40 is configured as a circuit device or a semiconductor device including the above-described component.

The device interface 402 includes a plurality of reception units 41, a plurality of transmission units 42, a plurality of protocol conversion units 43, and a plurality of communication control units 44. Hereinafter, the reception unit, the transmission unit, the protocol conversion unit, and the communication control unit will also be called “Rx”, “Tx”, “PCS”, and “CONT”, respectively. In the first embodiment, the device interface 402 includes n reception units 41-1 to 41-n, n transmission units 42-1 to 42-n, n protocol conversion units 43-1 to 43-n, and n communication control units 44-1 to 44-n. Each communication path 8 corresponds to any one of the plurality of reception units 41, any one of the plurality of transmission units 42, any one of the plurality of protocol conversion units 43, and any one of the plurality of communication control units 44. The reception unit 41, the transmission unit 42, the protocol conversion unit 43, and the communication control unit 44 corresponding to each communication path 8 function as a chain controller CC that transmits and receives a communication frame to and from the communication path 8. That is, the device interface 402 includes n chain controllers CC.

Each reception unit 41 is a reception circuit. The reception unit 41 corresponds to a physical layer. The reception unit 41 is coupled to the communication path 8 and the protocol conversion unit 43 corresponding to the reception unit 41. The reception unit 41 receives a communication frame from the cache device 9 via the communication path 8. The reception unit 41 performs physical processing such as waveform equalization on the received communication frame and supplies the processed communication frame to the protocol conversion unit 43.

Each transmission unit 42 is a transmission circuit. The transmission unit 42 corresponds to a physical layer. The transmission unit 42 is coupled to the communication path 8 and the protocol conversion unit 43 corresponding to the transmission unit 42. The transmission unit 42 performs physical processing such as waveform equalization on the communication frame supplied from the protocol conversion unit 43. The transmission unit 42 transmits the processed communication frame to the cache device 9 via the communication path 8.

Each protocol conversion unit 43 converts a protocol of a communication frame. The protocol conversion unit 43 corresponds to a link layer. The protocol conversion unit 43 is coupled to the communication control unit 44 corresponding to the protocol conversion unit 43. The protocol conversion unit 43 converts the protocol of a communication frame received from the communication control unit 44 according to a protocol corresponding to the communication path 8. The protocol conversion unit 43 transmits the protocol-converted communication frame to the transmission unit 42.

The protocol conversion unit 43 also converts the protocol of the processed communication frame received from the reception unit 41 according to a bus protocol of the internal bus 45. That is, the protocol conversion unit 43 converts the protocol of the processed communication frame received from the reception unit 41 according to the protocol of an upper layer, for example. The upper layer of the host controller 4 includes the internal bus 45, the CPU 46, the DRAM controller 47, the connector controller 48, the SRAM 49, and the DRAM 403, for example. The protocol conversion unit 43 transmits the protocol-converted communication frame to the communication control unit 44.

Each communication control unit 44 is configured to be capable of data insertion and extraction into and from the container. The communication control unit 44 corresponds to a link layer. The communication control unit 44 is coupled to the internal bus 45. The communication control unit 44 can insert data into the container. The data inserted into the container is data (packet) that is transmitted and received in a certain transmission unit between the communication control unit 44 and the upper layer of the host controller 4 corresponding to an operation executed in the upper layer, for example. The communication control unit 44 also extracts data from the container corresponding to the host controller 4 in the communication frame received from the protocol conversion unit 43, for example.

The CPU 46 is a processor. The CPU 46 controls the entire operations of the host controller 4. The CPU 46 controls the DRAM controller 47, the connector controller 48, and the SRAM 49 via the internal bus 45.

The DRAM controller 47 controls the DRAM 403 in response to a request from the CPU 46. The DRAM controller 47 transmits and receives data to and from the DRAM 403 via a signal line IOa.

The DRAM 403 is a volatile memory. The host controller 4 may include another volatile memory or non-volatile memory instead of the DRAM 403. The DRAM 403 temporarily stores information received by the circuit 40 from an external apparatus, data received from the communication devices 6 and the cache devices 9, and the like. The DRAM 403 may be included in the circuit 40. The DRAM 403 may be provided outside the host controller 4.

The connector controller 48 controls the connector interface 401 in response to a request from the CPU 46. The connector controller 48 transmits and receives information to and from an external apparatus via a signal line IOb, the connector interface 401, and the connector 3.

The SRAM 49 is a volatile memory. The host controller 4 may include, instead of the SRAM 49, another memory having an access speed higher than that of the DRAM 403. The SRAM 49 can be used as a work area of the CPU 46.

### 1.1.3 Configuration of Communication Device

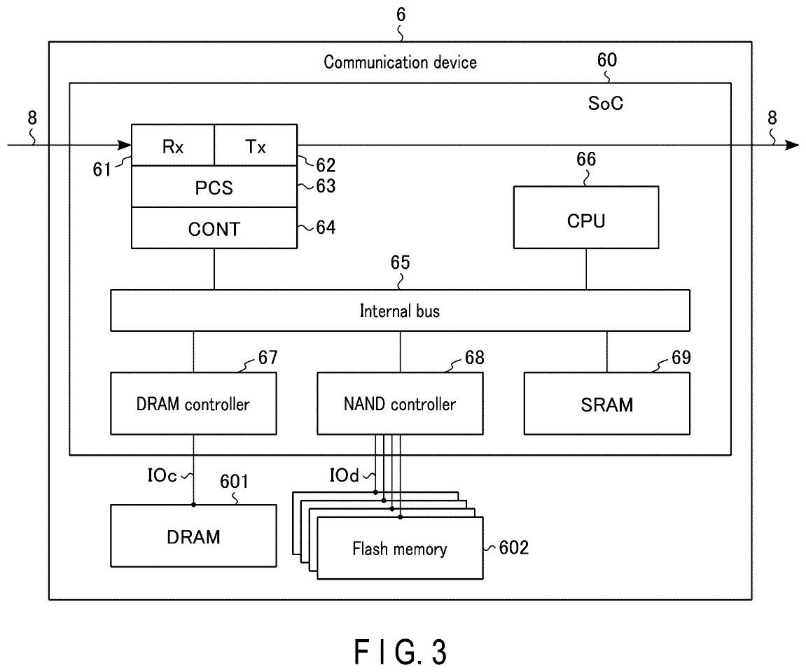

A configuration of each communication device 6 will be described with reference to FIG. 3. FIG. 3 is a block diagram illustrating an example of a communication device included in the communication system according to the first embodiment.

The communication device 6 includes a circuit 60, a DRAM 601, and a plurality of NAND flash memories 602. Hereinafter, the NAND flash memories 602 will also be called flash memories 602.

The circuit 60 is an integrated circuit such as an SoC, for example. The circuit 60 is a device that operates in response to a request from the host controller 4. The circuit 60 controls the DRAM 601 and the flash memories 602. For example, the circuit 60 commands the flash memories 602 to perform a read operation, a write operation, an erase operation, or the like. The circuit 60 includes a reception unit 61, a transmission unit 62, a protocol conversion unit 63, a communication control unit 64, an internal bus 65, a CPU 66, a DRAM controller 67, a NAND controller 68, and an SRAM 69. The circuit 60 is configured as a circuit device or a semiconductor device including these components.

The communication device 6 including the reception unit 61, the transmission unit 62, the protocol conversion unit 63, and the communication control unit 64 functions as an interface circuit that controls transmission and reception of data between the communication device 6 and another communication device 6 having the same components as those of the communication device 6 and controls transmission and reception of data between the cache device 9 and the communication device 6. The communication control unit 64, the CPU 66, the DRAM controller 67, the NAND controller 68, and the SRAM 69 are coupled to one another by the internal bus 65.

The reception unit 61 is a reception circuit. The reception unit 61 corresponds to a physical layer. The reception unit 61 is coupled to the communication path 8 and the protocol conversion unit 63. The reception unit 61 receives a communication frame from the cache device 9 or the communication device 6 at the preceding stage via the communication path 8. The reception unit 61 performs physical processing such as waveform equalization on the received communication frame and supplies the processed communication frame to the protocol conversion unit 63.

The transmission unit 62 is a transmission circuit. The transmission unit 62 corresponds to a physical layer. The transmission unit 62 is coupled to the communication path 8 and the protocol conversion unit 63. The transmission unit 62 performs physical processing such as waveform equalization on the communication frame supplied from the protocol conversion unit 63. The transmission unit 62 transmits the processed communication frame to the communication device 6 or the cache device 9 at the subsequent stage via the communication path 8.

The protocol conversion unit 63 converts a protocol of the communication frame. The protocol conversion unit 63 corresponds to a link layer. The protocol conversion unit 63 is coupled to the communication control unit 64. The protocol conversion unit 63 converts the protocol of the processed communication frame received from the reception unit 61 according to a bus protocol of the internal bus 65. That is, the protocol conversion unit 63 converts the protocol of the processed communication frame received from the reception unit 61 according to a protocol of an upper layer, for example. The upper layer of the communication device 6 includes the internal bus 65, the CPU 66, the DRAM controller 67, the NAND controller 68, the SRAM 69, the DRAM 601, and the flash memories 602, for example. The protocol conversion unit 63 transmits the communication frame protocol-converted according to the upper layer to the communication control unit 64.

The protocol conversion unit 63 also converts the protocol of the communication frame received from the communication control unit 64 according to a protocol of a lower layer. In the communication device 6, the lower layer is a layer lower than the physical layer. More specifically, the protocol conversion unit 63 converts the protocol of the communication frame received from the communication control unit 64 according to the protocol corresponding to the communication path 8. The protocol conversion unit 63 transmits the communication frame protocol-converted according to the lower layer to the transmission unit 62.

The communication control unit 64 is configured to be capable of data insertion and extraction into and from the container corresponding to the communication device 6. The communication control unit 64 corresponds to a link layer. The communication control unit 64 extracts data from the container corresponding to the communication device 6 in the communication frame received from the protocol conversion unit 63, for example. The communication control unit 64 can insert data into the container. In the communication device 6, the data inserted into the container is a packet transmitted and received between the communication control unit 64 and the upper layer of the communication device 6, in accordance with an operation executed in the upper layer or response data, for example.

The CPU 66 is a processor. The CPU 66 controls the entire operations of the communication device 6 in response to a request from the host controller 4. The CPU 66 controls the DRAM controller 67, the NAND controller 68, and the SRAM 69 via the internal bus 65. The CPU 66 commands the NAND controller 68 to perform a read operation, a write operation, an erase operation, or the like with respect to the flash memory 602, for example.

The DRAM controller 67 controls the DRAM 601 in response to a request from the CPU 66. The DRAM controller 67 transmits and receives data to and from the DRAM 601 via a signal line IOc.

The DRAM 601 is a volatile memory. The communication device 6 may include another volatile memory or non-volatile memory instead of the DRAM 601. The DRAM 601 temporarily stores data read from the flash memories 602, write data received from the host controller 4, and the like. The DRAM 601 may be included in the circuit 60.

The NAND controller 68 controls the flash memories 602. One NAND controller 68 can control the plurality of flash memories 602. The NAND controller 68 transmits and receives data to and from the flash memories 602 via signal lines IOd. For example, the NAND controller 68 transmits data (commands, addresses, write data, and the like) corresponding to a read operation, a write operation, an erase operation, or the like to the flash memories 602. The NAND controller 68 also receives the read data read from the flash memories 602 for the read operation.

The flash memories 602 are non-volatile storage media. The communication device 6 may include non-volatile storage media other than the NAND flash memories instead of the flash memories 602. The flash memories 602 store data received from the NAND controller 68 in a non-volatile manner. The flash memories 602 also read data stored in a non-volatile manner and transmits the data to the NAND controller 68.

The SRAM 69 is a volatile memory. The communication device 6 may include, instead of the SRAM 69, another memory having an access speed higher than that of the DRAM 601. The SRAM 69 can be used as a work area of the CPU 66.

### 1.1.4 Configuration of Cache Device

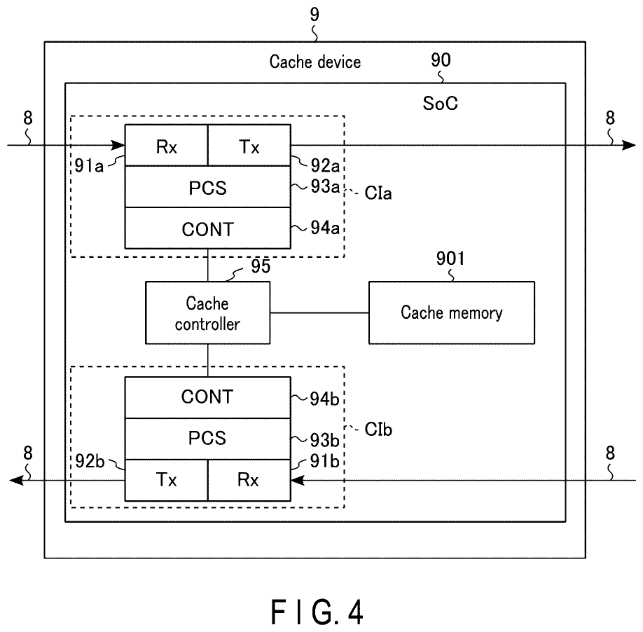

A configuration of each cache device 9 will be described with reference to FIG. 4. FIG. 4 is a block diagram illustrating an example of a cache device included in the communication system according to the first embodiment.

The cache device 9 includes a circuit 90. The circuit 90 is an integrated circuit such as an SoC, for example. The circuit 90 can operate in response to a request for an operation such as a read operation or a write operation from the host controller 4 to the communication device 6, for example. The circuit 90 includes reception units 91a and 91b, transmission units 92a and 92b, protocol conversion units 93a and 93b, communication control units 94a and 94b, a cache controller 95, and a cache memory 901. The circuit 90 is configured as a circuit device or a semiconductor device including these components.

In the following description, if the reception units 91a and 91b are not to be distinguished from each other, each of the reception units 91a and 91b will be simply called a reception unit 91. If the transmission units 92a and 92b are not to be distinguished from each other, each of the transmission units 92a and 92b will be simply called a transmission unit 92. If the protocol conversion units 93a and 93b are not to be distinguished from each other, each of the protocol conversion units 93a and 93b will be simply called a protocol conversion unit 93. If the communication control units 94a and 94b are not to be distinguished, each of the communication control units 94a and 94b will be simply called a communication control unit 94.

In each cache device 9, the reception unit 91a, the transmission unit 92a, the protocol conversion unit 93a, and the communication control unit 94a function as an interface circuit CIa that transmits and receives a communication frame. In addition, in each cache device 9, the reception unit 91b, the transmission unit 92b, the protocol conversion unit 93b, and the communication control unit 94b function as an interface circuit CIb that transmits and receives a communication frame. In this manner, each cache device 9 includes two interface circuits CIa and CIb. The communication control unit 94a, the communication control unit 94b, and the cache memory 901 are coupled via the cache controller 95.

The reception unit 91 (91a, 91b) is a reception circuit. The reception unit 91 corresponds to a physical layer. The reception unit 91a is coupled to the communication path 8 and the protocol conversion unit 93a. The reception unit 91a receives a communication frame from the host controller 4 via the communication path 8. The reception unit 91a performs physical processing such as waveform equalization on the received communication frame and supplies the processed communication frame to the protocol conversion unit 93a. The reception unit 91b is coupled to the communication path 8 and the protocol conversion unit 93b. The reception unit 91b receives the communication frame from the communication device 6-4 via the communication path 8. The reception unit 91b performs physical processing such as waveform equalization on the received communication frame and supplies the processed communication frame to the protocol conversion unit 93b.

The transmission unit 92 (92a, 92b) is a transmission circuit. The transmission unit 92 corresponds to a physical layer. The transmission unit 92a is coupled to the communication path 8 and the protocol conversion unit 93a. The transmission unit 92a performs physical processing such as waveform equalization on the communication frame supplied from the protocol conversion unit 93a. The transmission unit 92a transmits the processed communication frame to the communication device 6-1 via the communication path 8. The transmission unit 92b is coupled to the communication path 8 and the protocol conversion unit 93b. The transmission unit 92b performs physical processing such as waveform equalization on the communication frame supplied from the protocol conversion unit 93b. The transmission unit 92b transmits the processed communication frame to the host controller 4 via the communication path 8.

The protocol conversion unit 93 (93a, 93b) converts a protocol of a communication frame. The protocol conversion unit 93 corresponds to a link layer. The protocol conversion unit 93a is coupled to the communication control unit 94a. The protocol conversion unit 93a converts the protocol of the processed communication frame received from the reception unit 91a according to a protocol of an upper layer. The upper layer of the cache device 9 includes the cache controller 95 and the cache memory 901, for example. The protocol conversion unit 93a also transmits the communication frame protocol-converted according to the upper layer to the communication control unit 94a. The protocol conversion unit 93b is coupled to the communication control unit 94b. The protocol conversion unit 93b converts the protocol of the processed communication frame received from the reception unit 91b according to a protocol of the upper layer. The protocol conversion unit 93b also transmits the communication frame protocol-converted according to the upper layer to the communication control unit 94b.

The protocol conversion unit 93 also converts the protocol of the communication frame received from the communication control unit 94 according to the protocol of a lower layer. In the cache device 9, the lower layer is a layer lower than the physical layer. The protocol conversion unit 93a converts the protocol of the communication frame received from the communication control unit 94a according to the protocol corresponding to the communication path 8. The protocol conversion unit 93a transmits the communication frame protocol-converted according to the lower layer to the transmission unit 92a. The protocol conversion unit 93b converts the protocol of the communication frame received from the communication control unit 94b according to the protocol corresponding to the communication path 8. The protocol conversion unit 93b transmits the communication frame protocol-converted according to the lower layer to the transmission unit 92b.

The communication control unit 94 (94a, 94b) is configured to be capable of data insertion and extraction into and from the container. More specifically, the communication control unit 94a is configured to determine whether a packet (data) inserted into the container transmitted from the host controller 4 is cacheable data, for example. The fact that the packet (data) from the container is cacheable means that the communication control unit 94a can extract the packet (data) from the container. The communication control unit 94a extracts cacheable data from the container, for example. The communication control unit 94a does not extract non-cacheable data from the container, for example. On the other hand, the communication control unit 94b is configured to determine what kind of operation the data inserted into the container transmitted from the communication device 6-4 is based on, for example. The communication control unit 94b executes or does not execute data extraction according to the result of the determination. The determination and the operation based on the determination will be described later. The communication control unit 94 can insert data into the container. The data inserted into the container is a packet transmitted and received between each communication control unit 94 and the cache controller 95 in response to the operation in the cache device 9, for example. The communication control unit 94 corresponds to a link layer.

The cache controller 95 controls the cache memory 901 based on the communication frame received by each reception unit 91. The cache controller 95 also transmits and receives data to and from the cache memory 901. The cache controller 95 is also simply called a controller.

For example, the cache controller 95 is configured to determine whether a cache hit occurs if the data extracted from the container includes data on a request for a read operation or a write operation. The cache hit means that the data to be subjected to these operations (read data or write data) is stored in the cache memory 901, for example. In the following description, the absence of a cache hit will be called a cache miss. The cache controller 95 controls the entire operations of the cache device 9 according to the result of the determination.

The cache controller 95 is also configured to determine the free space of the cache memory 901, for example. For example, the cache controller 95 determines whether the cache is full (cashe full) or close to full. The cache full means that there is no free space for storing data in the cache memory 901, for example. The cache controller 95 controls the entire operations of the cache device 9 so as to secure the free space of the cache memory 901 according to the result of the determination.

For example, the cache controller 95 also controls the entire operations of the cache device 9 so as to execute a write-back operation in response to a request transmitted from the host controller 4 via the communication frame. The write-back operation is an operation of writing a part or all of the data stored in the cache memory 901 to the communication device 6 and erasing the data from the cache memory 901, for example.

The cache memory 901 is a volatile memory. The cache memory 901 is an SRAM, for example. The cache memory 901 is also simply called a memory. The cache device 9 may include another volatile memory or non-volatile memory controlled by the cache controller 95 instead of the cache memory 901, for example. The cache memory 901 stores write data received from the host controller 4, read data received from the communication devices 6, and the like. The cache memory 901 may be provided outside the circuit 90.

In the above description, the reception unit 91a is coupled to the host controller 4 and the transmission unit 92a is coupled to the communication device 6-1 in the interface circuit CIa, and the reception unit 91b is coupled to the communication device 6-4 and the transmission unit 92b is coupled to the host controller 4 in the interface circuit CIb. However, these connection relationships may be reversed. That is, the reception unit 91a may be coupled to the communication device 6-4 and the transmission unit 92a may be coupled to the host controller 4 in the interface circuit CIa, and the reception unit 91b may be coupled to the host controller 4 and the transmission unit 92b may be coupled to the communication device 6-1 in the interface circuit CIb.

### 1.1.5 Configuration of Cache Memory

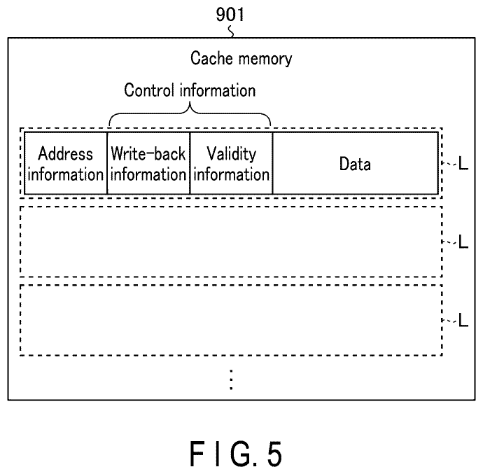

An example of a configuration of the cache memory 901 will be described with reference to FIG. 5. FIG. 5 is a diagram illustrating an example of a configuration of the cache memory in the communication system according to the first embodiment.

The cache memory 901 includes a plurality of lines L each of which stores data. The line L is a unit for managing a plurality of data stored in the cache memory 901. Each line L includes data, address information, and control information. The control information includes write-back information and validity information, for example.

Each data managed by the lines L is data to be subjected to a read operation or a write operation from and to the communication device 6, for example.

The address information is information related to an address of data included in each line L. That is, the address information is information related to the address of the communication device 6 in which the data is stored or the address of the communication device 6 to which the data is written, for example. The address information includes an upper address (address tag) of the communication device 6, for example.

The write-back information is information for identifying whether the data included in each line L is in a state in which the write-back operation needs to be executed (“Dirty state”) or in a state in which the write-back operation does not need to be executed (“Clean state”). The state in which the write-back operation needs to be executed is a state in which data included in each line L (data corresponding to the address information) is rewritten, for example. The state in which the write-back operation does not need to be executed is a state in which the data included in each line L is maintained, for example.

The validity information is information indicating whether the data included in each line L is valid.

### 1.1.6 Configuration of Communication Frame

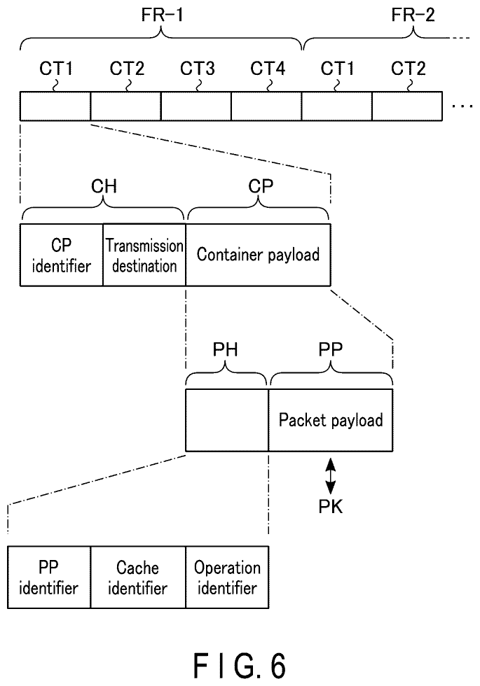

An example of a configuration of a communication frame will be described with reference to FIG. 6. FIG. 6 is a diagram illustrating an example of a communication frame in the communication system according to the first embodiment.

A plurality of communication frames FR is sequentially transmitted from the host controller 4. In the example of FIG. 6, among the plurality of communication frames FR, a communication frame FR-1 and a part of a communication frame FR-2 are illustrated. Each communication frame FR has a plurality of containers CT having the same fixed length, for example. In the example of FIG. 6, each communication frame FR includes four containers CT (CT1 to CT4). The number of containers CT included in each communication frame FR is not limited to four. The number of containers CT included in each communication frame FR may be the number according to the band required for the communication system 1, the band of each communication device 6, the number of communication devices 6, or the like, for example.

Each container CT can contain data to be inserted and extracted into and from the host controller 4, any of the plurality of communication devices 6, or the cache device 9, for example. Each container CT may be in an empty state in which no data is contained.

Each container CT includes a container header CH and a container payload CP.

The container header CH includes a CP identifier and transmission destination information. The container header CH may include transmission source information. The transmission source information includes an identification information ID for identifying the transmission source of the container CT. The CP identifier is an identifier for identifying the start of the container payload CP and the end of the container payload CP in a case where the plurality of containers CT is collectively transferred. The transmission destination information includes an identification information ID for identifying the transmission destination of the container CT. In the following description, identification information IDs of the host controller 4, the communication device 6-1, the communication device 6-2, the communication device 6-3, and the communication device 6-4 will be called identification information ID0, ID1, ID2, ID3, and ID4, respectively. The transmission destination information can include the identification information ID0 of the host controller 4 or the identification information ID (any one of ID1 to ID4) of one of the plurality of communication devices 6-1 to 6-4, for example.

The container payload CP includes data transmitted and received between the lower layer and the upper layer. The container payload CP includes a packet header PH and a packet payload PP. The container payload CP may include a plurality of packet payloads PP, for example.

The packet header PH includes a PP identifier, a cache identifier, and an operation identifier, for example. The PP identifier is an identifier for identifying the start of the packet payload PP and the end of the packet payload PP in a case where the plurality of packet payloads PP is collectively transferred. The cache identifier is an identifier for identifying whether the data inserted into the container CT is cacheable data. The communication control unit 94 can determine whether the data inserted into the container CT is cacheable data based on the cache identifier. For example, if the container CT includes a request for an operation, the operation identifier serves as an identifier for identifying for what type of operation the request is, and which of the host controller 4 and the cache device 9 made the request. If the container CT includes response data or read data, the operation identifier serves as an identifier for identifying what type of operation the data is based on and which of the host controller 4 and the cache device 9 requested the operation related to the data, for example. If the container CT includes response data or read data, the operation identifier is configured to be capable of identifying the address of the communication device 6 corresponding to the response data or the read data, for example. The communication control unit 94b can determine on what type of operation the data inserted into the container CT is based, by using the operation identifier. The operation identifier includes a read identifier based on the host controller 4 and the cache device 9, and a write identifier based on the host controller 4 and the cache device 9, for example. The read identifier is an identifier for a case where the container CT includes a request for a read operation or read data. The write identifier is an identifier for a case where the container CT includes a request for a write operation or response data of a write operation. An operation identifier for identifying a request for an operation by the host controller 4 or response data or read data based on the request will also be called an operation identifier based on the host controller 4. An operation identifier for identifying a request for an operation by the cache device 9 or response data or read data based on the request will also be called an operation identifier based on the cache device 9.

The packet header PH may include a command such as a cache clear command, for example. The cache clear command is a command for instructing a write-back operation of some or all data stored in the cache memory 901.

The packet payload PP includes data or response data related to an operation executed in an upper layer of the communication device 6, for example. In other words, the packet payload PP includes data of a packet PK or data of a response packet transmitted and received between the communication control unit 64 and the upper layer of the communication device 6 corresponding to the communication control unit 64. More specifically, if the packet payload PP includes data related to an operation executed in the upper layer of the communication device 6, the packet payload PP includes information (address) indicating the transmission destination, attribute information (command) such as a read operation, a write operation, or an erase operation executed in the upper layer, data (write data, read data, or the like), information of a packet length, and the like, for example. If a write operation is executed in the flash memory 602, the packet payload PP transmitted from the lower layer to the upper layer of the communication device 6 includes a write command, an address, and write data, for example. If a read operation is executed in the flash memory 602, the packet payload PP transmitted from the upper layer to the lower layer of the communication device 6 includes read data, for example.

### 1.2 Operations

Next, operations of the communication system 1 according to the first embodiment will be described. Hereinafter, first, an example of operations on the communication frame FR by each communication device 6 in the first embodiment will be described with reference to a flowchart. Then, an example of operations on the communication frame FR by each cache device 9 in the first embodiment will be described using a plurality of operation examples of the communication system 1 according to the first embodiment.

### 1.2.1 Operations of Communication Device

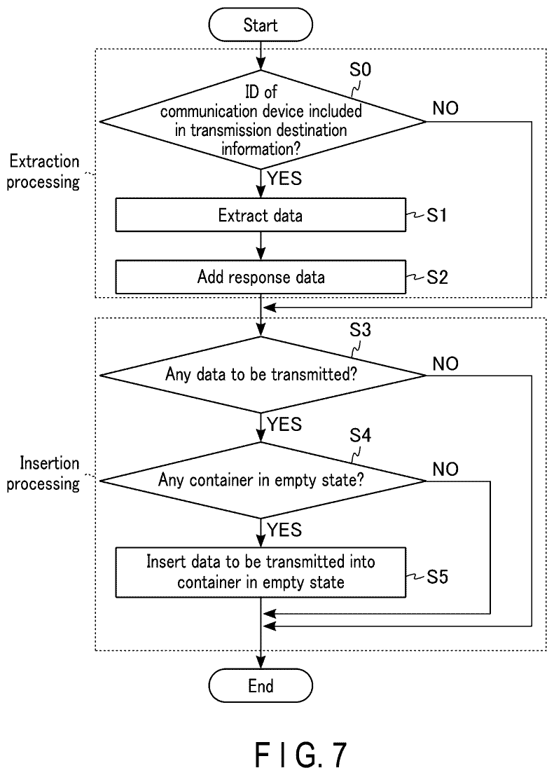

An example of the operation of each communication device 6 will be described with reference to FIG. 7. FIG. 7 is a flowchart describing an example of operations of the communication device in the communication system according to the first embodiment. Specifically, FIG. 7 is an example of operation on the communication frame FR by the communication device 6.

In the communication device 6 that has received the communication frame FR, the communication control unit 64 determines whether the identification information ID of the communication device 6 is included as the transmission destination information in the container header CH of each container CT of the communication frame FR (S0). When the identification information ID of the communication device 6 is not included as the transmission destination information (S0: NO), the process proceeds to S3.

When the identification information ID of the communication device 6 is included as the transmission destination information (S0: YES), the communication control unit 64 extracts the data from the packet payload PP of the container CT including the identification information ID of the communication device 6 (S1). The communication control unit 64 also transmits the extracted data to the upper layer as the packet PK. Then, the CPU 66 executes an operation such as a write operation, a read operation, or an erase operation based on the extracted data. The communication control unit 64 deletes the identification information ID of the communication device 6 (operating communication device 6) that has executed the data extraction, from the transmission destination information of the container CT from which the data has been extracted. The communication control unit 64 may delete not only the identification information ID but also the address of the transmission destination in the operating communication device 6. However, since the address of the transmission destination in the operating communication device 6 is not used in the communication device 6 at the subsequent stage, the communication control unit 64 updates the transmission destination information but may not delete the address of the transmission destination. Then, the process proceeds to S2.

For example, the communication control unit 64 adds response data for the operation based on the data extracted in S1 to the data to be transmitted (S2). If a read operation is executed in S1, the communication control unit 64 adds the read data to the data to be transmitted, for example. The data to be transmitted is stored in the DRAM 601 or the flash memory 602 of the operating communication device 6, for example. If there is no data to be transmitted in the operating communication device 6 at the execution of data extraction, the communication control unit 64 sets the above-described added data as data to be transmitted. Then, the process proceeds to S3.

The communication control unit 64 determines whether there is data to be transmitted in the operating communication device 6 (S3). When there is data to be transmitted (S3: YES), the process proceeds to S4. When there is no data to be transmitted (S3: NO), the process on the communication frame FR is ended. If the identification information ID of the operating communication device 6 is not included (S0: NO) and there is no data to be transmitted (S3: NO), the process related to data insertion and extraction into and from the communication frame FR by the operating communication device 6 is not executed.

The communication control unit 64 determines whether there is any container CT in an empty state (S4). If there is no container CT in an empty state (S4: NO), the process on the communication frame FR is ended. If the identification information ID of the operating communication device 6 is not included (S0: NO) and there is any data to be transmitted (S3: YES) but there is no container CT in an empty state (S4: NO), the process related to data insertion and extraction into and from the communication frame FR by the operating communication device 6 is not executed.

If there is any container CT in an empty state (S4: YES), the communication control unit 64 inserts the data to be transmitted into the container CT in the empty state (S5). More specifically, the communication control unit 64 converts the transmission destination information of the container header CH in the container CT in the empty state into the identification information ID0 of the host controller 4. The communication control unit 64 inserts the data to be transmitted into the container payload CP in the container CT in the empty state. The communication control unit 64 also inserts the operation identifier of the data to be transmitted into the container payload CP in the container CT into which the data to be transmitted is to be inserted, for example. The communication control unit 64 also inserts a cache identifier of the data to be transmitted indicating that the data is not cacheable, into the container payload CP in the container CT, for example. Then, the process on the communication frame FR is ended.

For example, if the data to be transmitted is data based on an operation requested by the host controller 4, the operation identifier of the data to be transmitted is an operation identifier based on the host controller 4. Furthermore, for example, if the data to be transmitted is data based on an operation requested by the cache device 9, the operation identifier of the data to be transmitted is an operation identifier based on the cache device 9.

In the operations of the communication device 6 as described above, the processing in S0 to S2 can be called extraction processing. In addition, the processing in S3 to S5 can be called insertion processing.

The communication frame FR updated as described above is transmitted from the transmission unit 62. Then, the processing in the communication device 6 is ended.

### 1.2.2 Operations of Cache Device

Operations of the cache device 9 will be described using the entire operations of the communication system 1. Hereinafter, the operations of the cache device 9 will be specifically described using a first operation example to an eighth operation example of the communication system 1 according to the first embodiment.

As the first operation example of the communication system 1 according to the first embodiment, an operation example of a case in which a cache hit occurs for a read operation request will be described. As the second operation example of the communication system 1 according to the first embodiment, an operation example of a case in which the cache is not full when a cache miss occurs for a read operation request will be described. As the third operation example of the communication system 1 according to the first embodiment, an operation example of a case in which the cache is full when a cache miss occurs for a read operation request will be described. As the fourth operation example of the communication system 1 according to the first embodiment, an operation example of a case in which a cache hit occurs for a write operation request will be described. As the fifth operation example of the communication system 1 according to the first embodiment, an operation example of a case in which the cache is not full when a cache miss occurs for a write operation request will be described. As the sixth operation example of the communication system 1 according to the first embodiment, an operation example of a case in which the cache is full when a cache miss occurs for a write operation request will be described. As the seventh operation example of the communication system 1 according to the first embodiment, an operation example of a case in which an eviction operation is executed when the cache is full or when the cache is close to full will be described. The eviction operation is an operation of erasing at least part of the data stored in the cache memory 901 from the cache memory 901. As the eighth operation example of the communication system 1 according to the first embodiment, an operation example of a case in which a write-back operation is executed in response to a cache clear command will be described.

In diagrams illustrating the operation examples described below, the host controller 4, one device board 5 coupled to the host controller 4, and the cache device 9 corresponding to the device board 5 are illustrated. In the configuration of each communication device 6, the DRAM 601, the plurality of flash memories 602, the CPU 66, the DRAM controller 67, and the SRAM 69 are not illustrated in the drawings. In the configuration of the cache device 9, the cache memory 901 is not illustrated in the drawings.

### 1.2.2.1 First Operation Example of First Embodiment

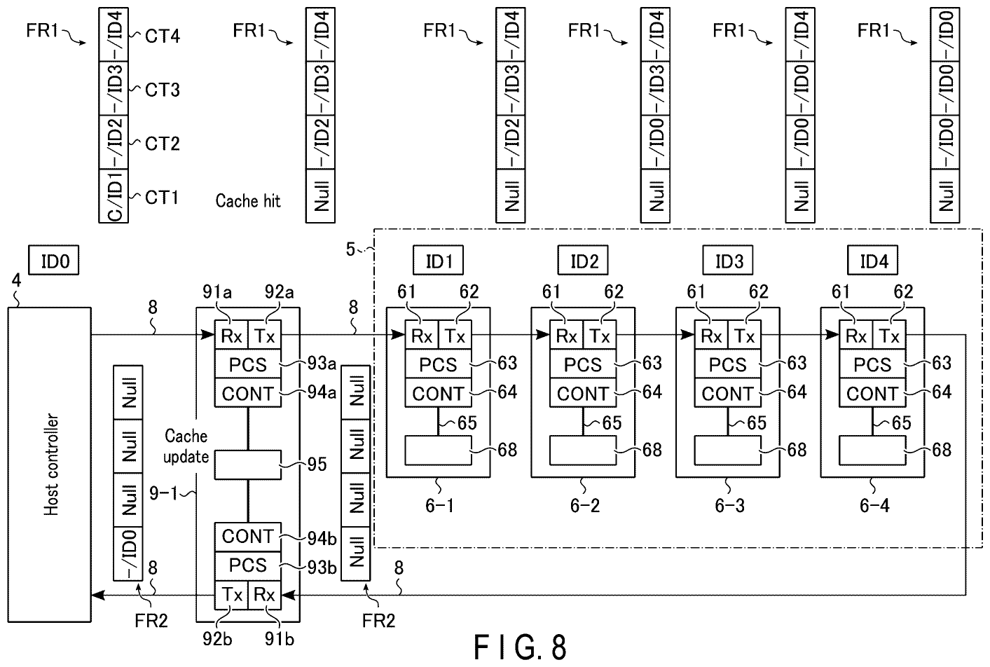

The first operation example of the communication system 1 according to the first embodiment will be described with reference to FIG. 8. FIG. 8 is a diagram illustrating the first operation example in the communication system according to the first embodiment. Hereinafter, an example of a case where a cache hit occurs for a read operation request will be described as the first operation example of the first embodiment with reference to FIG. 8.

For example, the host controller 4 transmits to the cache device 9, a communication frame FR1 in which data corresponding to the identification information ID1 (the communication device 6-1) is contained in the container CT1, data corresponding to the identification information ID2 (the communication device 6-2) is contained in the container CT2, data corresponding to the identification information ID3 (the communication device 6-3) is contained in the container CT3, and data corresponding to the identification information ID4 (the communication device 6-4) is contained in the container CT4. The container CT1 contains a command and an address for requesting a read operation to the communication device 6-1, for example. The containers CT2, CT3, and CT4 contain commands, addresses, and write data for requesting a write operation to the communication devices 6-2, 6-3, and 6-4, respectively, for example. The cache identifier of the data inserted into the container CT1 is an identifier indicating that the data is cacheable data. That is, the container CT1 is a container CT including cacheable data. The cache identifiers of the data inserted into the containers CT2, CT3, and CT4 are identifiers indicating that the data is not cacheable data. That is, the containers CT2, CT3, and CT4 are containers CT that do not include cacheable data. In the drawings described below, the symbol “C/” is attached to the container CT including the cacheable data. The symbol “-/” is attached to the containers CT not including cacheable data. The operation identifier of the request contained in the container CT1 of the communication frame FR1 transmitted from the host controller 4 is a read identifier based on the host controller 4. The operation identifiers of the requests contained in the containers CT2 to CT4 of the communication frame FR1 transmitted from the host controller 4 are write identifiers based on the host controller 4. In the drawings described below, the symbol “Null” is attached to the containers CT in an empty state.

At the transmission of the communication frame FR1 from the host controller 4, the cache memory 901 of the cache device 9 stores read data that is the target of the read operation request contained in the container CT1.

In the cache device 9 that has received the communication frame FR from the host controller 4, the communication control unit 94a of the cache device 9 determines whether the data inserted into the container CT is cacheable data based on the cache identifier of the packet header PH of each container CT included in the communication frame FR. If it is determined that the data inserted into the container CT is not cacheable data, the cache device 9 does not extract the data.

The cache controller 95 determines whether cache hit occurs for the cacheable data. More specifically, the communication control unit 94a extracts cacheable data from the packet payload PP of the container CT. The communication control unit 94a transmits the extracted data as the packet PK to the upper layer. The cache controller 95 determines whether read data to be the target of a read operation or write data to be the target of a write operation is stored in the cache memory 901 based on the extracted data, for example.

If it is determined that a cache hit has occurred for the read operation request included in the container CT, the communication control unit 94a extracts the read operation request from the container CT. If the data included in the container CT is only the read operation request, the communication control unit 94a sets the container CT as a container CT in the empty state, for example. The cache controller 95 updates the cache memory 901 using the extracted read operation request, for example. The cache controller 95 adds the read data that is the target of the read operation to data to be transmitted in order to transmit the read data to the host controller 4, for example.

In the first operation example of the first embodiment, the communication control unit 94a determines that the data contained in the container CT1 is cacheable data. The cache controller 95 determines that a cache hit has occurred for the read operation request contained in the container CT1. Then, the cache memory 901 is updated using the read operation request. The communication control unit 94a sets the container CT1 as a container CT in the empty state. In the diagrams illustrating the operation examples, the update of the cache memory 901 is simply referred to as “cache update”. The read data set as the target of the read operation request extracted from the container CT1 of the communication frame FR1 is added to the data to be transmitted in order to transmit the read data to the host controller 4. The communication control unit 94a determines that the data contained in the containers CT2 to CT4 is not cacheable data. Accordingly, the cache device 9 does not execute data extraction for the containers CT2 to CT4. In this manner, the communication frame FR1 is updated. The cache device 9 transmits the updated communication frame FR1 to the communication device 6-1.

The cache device 9 receives a communication frame FR2 transmitted from the communication device 6-4. At this time, if the cache device 9 includes read data as data to be transmitted, the communication control unit 94b inserts the data to be transmitted into the container CT in the empty state of the communication frame FR2. The communication control unit 94b also converts the transmission destination information of the container CT into the identification information ID0 of the host controller 4. The communication control unit 94b inserts a read identifier based on the host controller 4 into the container CT as an operation identifier of the data to be transmitted, for example. At the time of insertion of the data to be transmitted into the container CT in the empty state, the communication control unit 94b sets the cache identifier of the data to be transmitted as an identifier indicating that the data is not cacheable, for example.

In the first operation example of the first embodiment, after the read data extracted from the container CT1 of the communication frame FR1 is added to the data to be transmitted as described above, the cache device 9 receives the communication frame FR2 from the communication device 6-4. The communication frame FR2 includes containers CT1 to CT4 in an empty state, for example. The communication control unit 94b inserts the data to be transmitted into the container CT1 with the host controller 4 as a transmission destination. The communication control unit 94b inserts a read identifier based on the host controller 4 into the container CT1 as an operation identifier of the data to be transmitted. In this manner, the communication frame FR2 transmitted to the host controller 4 is updated. The communication control unit 94b also transmits the updated communication frame FR2 to the host controller 4.

The data to be transmitted can be transmitted to the host controller 4 by the communication control unit 94b at a timing independent of the processing on the communication frames FR in the communication devices 6-1 to 6-4. For example, in the first operation example of the first embodiment, the data to be transmitted can be transmitted to the host controller 4 using the communication frame FR2 at a timing earlier than each processing on the communication frames FR1 in the communication devices 6-1 to 6-4.

In the communication device 6-1, data extraction from the communication frame FR1 and update of the communication frame FR1 are not executed. Then, the communication device 6-1 transmits the communication frame FR1 having the same contents as those of the received communication frame FR1 to the communication device 6-2.

In the communication device 6-2, data of the container CT2 included in the communication frame FR1 is extracted. The CPU 66 executes a write operation on the flash memory 602 based on the extracted data. The communication control unit 64 inserts response data of the write operation into the container CT2. The communication control unit 64 converts the transmission destination information of the container header CH of the container CT2 from the identification information ID2 to the identification information ID0. In this manner, the communication frame FR1 is updated. The communication device 6-2 transmits the updated communication frame FR1 to the communication device 6-3. For example, when each communication device 6 inserts response data into the container CT, the communication device 6 maintains a cache identifier for the response data as an identifier indicating that the data is not cacheable, for example. In the first operation example of the first embodiment, the communication control unit 64 maintains the operation identifier of the response data of the write operation as a write identifier based on the host controller 4.

In each of the communication devices 6-3 and 6-4, processing on the containers CT3 and CT4 included in the communication frame FR1 is executed in the same manner as the processing in the communication device 6-2. Accordingly, the communication frame FR1 is updated. The communication device 6-4 transmits the updated communication frame FR1 to the cache device 9.

When the cache device 9 receives the communication frame FR from the communication device 6-4, the communication control unit 94b determines the operation identifier of the data for each container CT in which the data is contained. That is, the communication control unit 94b determines from what operation the data contained in each container CT is, and whether the data is data related to the operation requested by the host controller 4 or the cache device 9, for example. If the communication control unit 94b determines that the operation identifier of the data contained in each container CT is a write identifier based on the host controller 4, the cache device 9 does not execute the extraction of the data. Operation examples of cases where the communication control unit 94b determines that the operation identifier contained in each container CT is a read identifier based on the host controller 4, and a write identifier and a read identifier based on the cache device 9 will be described later.

In the first operation example of the first embodiment, after the end of the transmission of the data to be transmitted to the host controller 4 using the communication frame FR2, for example, the cache device 9 receives the updated communication frame FR1 from the communication device 6-4. At this time, the container CT1 of the communication frame FR1 is a container CT in an empty state. Write identifiers based on the host controller 4 are inserted into the containers CT2 to CT4. The cache device 9 does not include data to be transmitted to the host controller 4, for example. Accordingly, the cache device 9 does not execute extraction and insertion of data from and into the communication frame FR1.

This ends the processing of the first operation example of the first embodiment.

As described above, if it is determined that a cache hit occurs for a request for a read operation on the communication device 6, the read operation on the communication device 6 is not executed. The read data stored in the cache device 9 is transmitted to the host controller 4.

### 1.2.2.2 Second Operation Example of First Embodiment

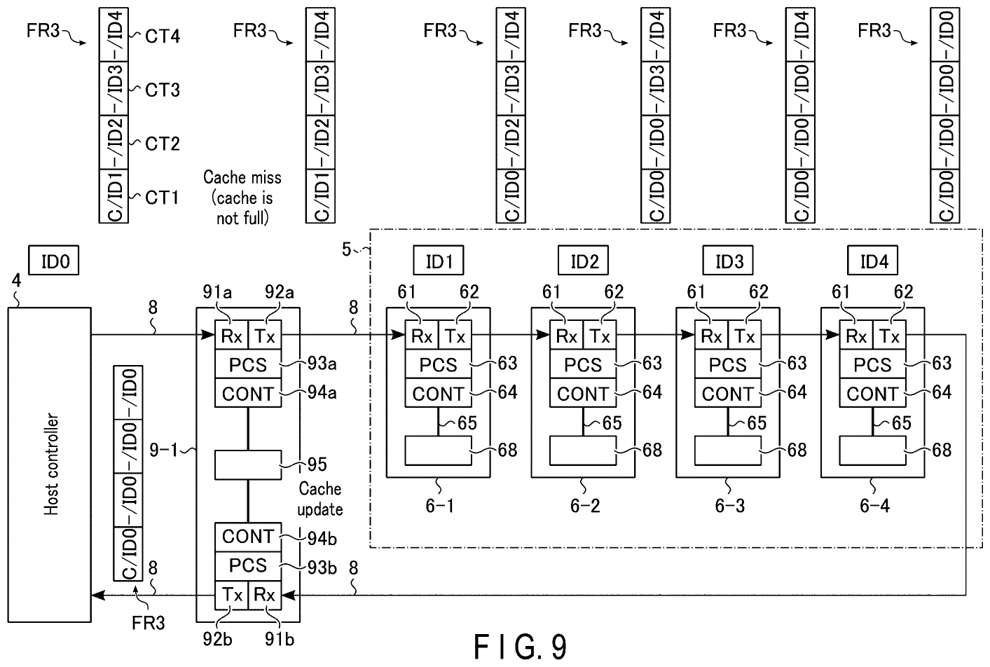

A second operation example of the communication system 1 according to the first embodiment will be described with reference to FIG. 9. FIG. 9 is a diagram illustrating the second operation example in the communication system according to the first embodiment. Hereinafter, an example of a case where the cache is not full when a cache miss occurs for a read operation request will be described with reference to FIG. 9, as the second operation example of the first embodiment.

A communication frame FR3 transmitted from the host controller 4 in the second operation example of the first embodiment is similar to the communication frame FR1 transmitted from the host controller 4 in the first operation example of the first embodiment.

At the transmission of the communication frame FR3 from the host controller 4, the cache memory 901 of the cache device 9 does not store read data that is the target of the read operation request contained in the container CT1. At this time, an example of a case where the cache is not full will be described.

If the cache device 9 having received the communication frame FR from the host controller 4 determines that a cache miss has occurred for the read operation request contained in the container CT, the cache controller 95 determines whether the cache is full. If it is determined that the cache is not full, the communication control unit 94a changes the content of the packet stored in the container CT to a request for a read operation of line fill data, for example. The line fill data is read data that is read from the communication device 6 that stores data to be subjected to a read operation or a write operation when the cache device 9 determines that a cache miss has occurred when there is a request for the read operation or the write operation. The communication control unit 94a maintains the operation identifier of the request for the read operation of the line fill data as a read identifier based on the host controller 4. The communication control unit 94a sets the cache identifier of the request for the read operation of the line fill data as an identifier indicating that the data is cacheable, for example.

In the second operation example of the first embodiment, the communication frame FR3 transmitted from the host controller 4 is received. At this time, in the cache device 9, the cache controller 95 determines that a cache miss has occurred for the read operation request contained in the container CT1. The communication control unit 94a changes the content of the packet in the container CT1 to a request for a read operation of line fill data. In the second operation example of the first embodiment, the line fill data includes data corresponding to the read operation request extracted from the container CT1 of the communication frame FR3, and is data stored in the communication device 6-1. The communication control unit 94a maintains the operation identifier of the read operation request as a read identifier based on the host controller 4. The communication control unit 94a also sets the cache identifier of the read operation request as an identifier indicating that the data is cacheable. The communication control unit 94a does not extract data from the containers CT2 to CT4 not including cacheable data. In this manner, the communication frame FR3 is updated. The cache device 9 transmits the updated communication frame FR3 to the communication device 6-1.

In the communication device 6-1, data of the container CT1 is extracted. The CPU 66 executes a read operation of line fill data on the flash memory 602 based on the extracted data. The communication control unit 64 inserts the read data (line fill data) into the packet payload PP of the container CT1. The communication control unit 64 converts the transmission destination information of the container header CH of the container CT1 from the identification information ID1 to the identification information ID0. The communication control unit 64 sets the operation identifier of the read data as a read identifier based on the host controller 4. The communication control unit 64 sets the cache identifier of the read data as a cache identifier indicating that the data is cacheable. In this manner, the communication frame FR3 is updated. The communication device 6-1 transmits the updated communication frame FR3 to the communication device 6-2.

The processing on the communication frame FR3 in the communication devices 6-2 to 6-4 is the same as that on the communication frame FR1 in the first operation example of the first embodiment. The communication device 6-4 transmits the updated communication frame FR3 to the cache device 9.

The cache device 9 receives the communication frame FR from the communication device 6-4. At this time, if the communication control unit 94b determines that the operation identifier of the data contained in a certain container CT is a read identifier based on the host controller 4, the read data (line fill data) contained in the container CT is extracted. The cache device 9 updates the cache memory 901 using the read data. More specifically, the communication control unit 94b extracts the read data (line fill data) from the packet payload PP of the container CT. The communication control unit 94b also transmits the extracted data to the upper layer as the packet PK. The cache controller 95 updates the cache memory 901 using the extracted read data (line fill data). The communication control unit 94b inserts the read data to be transmitted to the host controller 4 based on the request for the read operation of the line fill data into the packet stored in the container CT, for example. Accordingly, the cache device 9 transmits, to the host controller 4, the communication frame FR including the container CT in which the read data in response to the request for the read operation of the line fill data is contained in the communication frame FR transmitted from the communication device 6-4. In this manner, the cache device 9 updates the cache memory 901 using the line fill data based on the read operation request transmitted from the host controller 4. The cache device 9 also transmits the read data based on the read operation request to the host controller 4. The read data based on the read operation request is data corresponding to at least a part of the read data of the line fill data, for example.

In the second operation example of the first embodiment, in the cache device 9 that has received the communication frame FR3 transmitted from the communication device 6-4, the communication control unit 94b determines that the operation identifier of the data contained in the container CT1 is a read identifier based on the host controller 4. The cache controller 95 updates the cache memory 901 using the line fill data included in the container CT1. The communication control unit 94b sets the container CT1 to be transmitted to the host controller 4 as a container CT equivalent to the container CT1 transmitted from the communication device 6-4. The containers CT2 to CT4 of the communication frame FR3 are not updated. The cache device 9 does not update the communication frame FR3 transmitted from the communication device 6-4. That is, the cache device 9 transmits the communication frame FR3 having the same contents as those of the communication frame FR3 transmitted from the communication device 6-4 to the host controller 4.

This ends the processing of the second operation example of the first embodiment.

As described above, if the occurrence of a cache miss is determined for a request for a read operation to the communication device 6 and the cache is not full, the cache memory 901 is updated by the line fill data read from the communication device 6 in response to the request for the read operation. In response to the request for the read operation to the communication device 6, the read data based on the line fill data is transmitted to the host controller 4.

### 1.2.2.3 Third Operation Example of First Embodiment

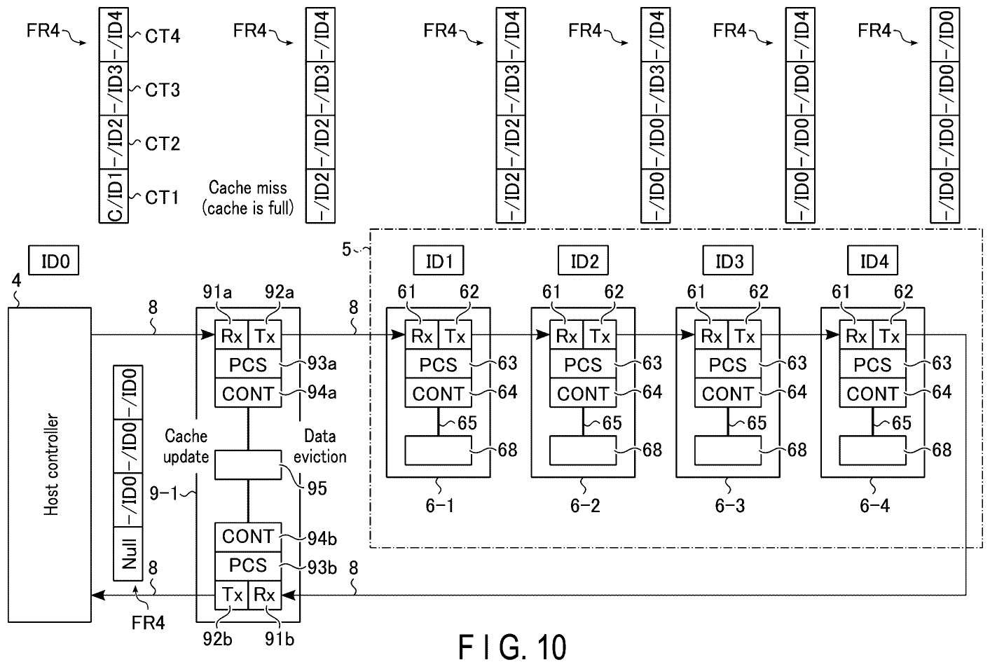

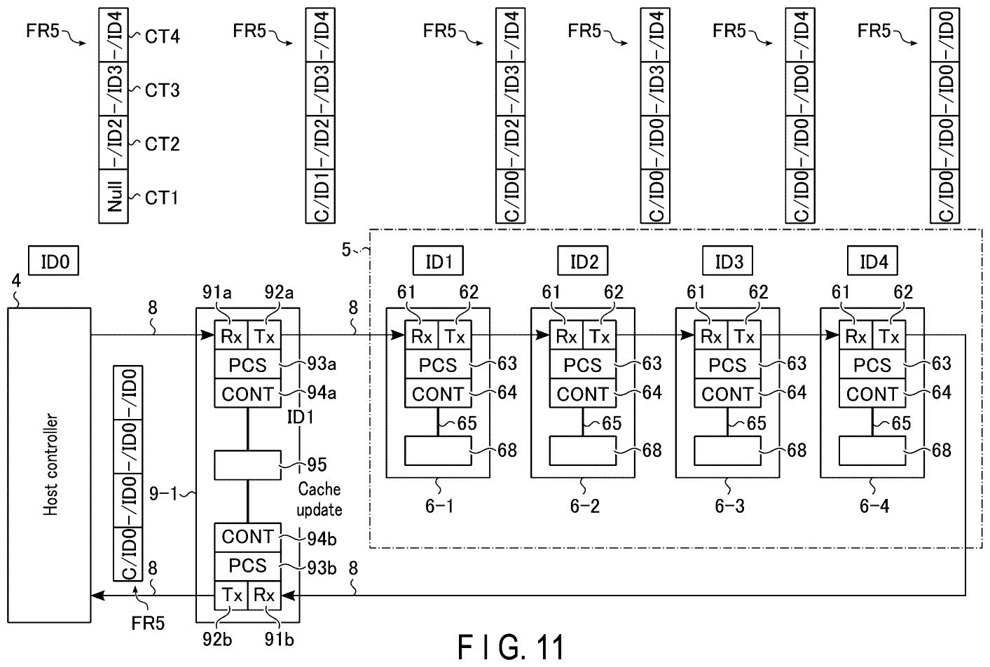

A third operation example of the communication system 1 according to the first embodiment will be described with reference to FIGS. 10 and 11. FIGS. 10 and 11 are diagrams illustrating the third operation example in the communication system according to the first embodiment. Hereinafter, an example of a case where the cache is full when a cache miss occurs for a read operation request will be described with reference to FIGS. 10 and 11 as the third operation example of the first embodiment.

A communication frame FR4 transmitted from the host controller 4 in the third operation example of the first embodiment is similar to the communication frames FR1 and FR3 transmitted from the host controller 4 in the first operation example and the second operation example of the first embodiment.

At the transmission of the communication frame FR4 from the host controller 4, the cache memory 901 of the cache device 9 does not store read data that is the target of the read operation request contained in the container CT1. At this time, an example of a case where the cache is full will be described.

If the cache device 9 that has received the communication frame FR from the host controller 4 determines that a cache miss has occurred for the read operation request contained in the container CT and the cache is full, the communication control unit 94a extracts the read operation request from the container CT. If the data included in the container CT is only the read operation request, the communication control unit 94a sets the container CT as a container CT in the empty state, for example. The cache controller 95 executes an eviction operation based on the read operation request. In the drawings described below, the eviction operation is simply indicated as “data eviction”.

In the eviction operation based on the read operation request, the cache controller 95 selects the eviction data from the data stored in the cache memory 901, for example. The eviction data can be selected by a latest recently used (LRU) method, a first in first out (FIFO) method, or the like, for example. The eviction data may be randomly selected. The cache controller 95 erases the selected eviction data from the cache memory 901. The eviction operation as described above secures the free space of the cache memory 901. The eviction data is erased for each line L, for example.

As the eviction data selected as described above is erased, the eviction data may be written to the communication device 6. That is, the write-back operation based on the read operation request may be executed. In this case, the communication control unit 94a inserts the selected eviction data into the container CT in the empty state as described above, together with a write operation request, for example. The communication control unit 94a sets the transmission destination information of the container CT into which the eviction data is inserted as the identification information ID of the communication device 6 that is the target of the write operation of the eviction data. The communication control unit 94a then inserts a write identifier based on the cache device 9 into the container CT as the operation identifier of the eviction data, for example. The communication control unit 94a also inserts an identifier indicating that the data is not cacheable into the container CT as the cache identifier of the eviction data, for example. Then, the cache controller 95 erases the eviction data from the cache memory 901.

The cache controller 95 determines whether to execute a write-back operation based on a read operation request, based on the write-back information or the validity information of the line L including the eviction data, for example. For example, if the write-back information of the line L including the eviction data indicates the “Dirty state” or if the validity information of the line L including the eviction data indicates that the data is valid, the cache controller 95 determines that a write-back operation is to be executed. For example, if the write-back information of the line L including the eviction data indicates the “Clean state” or if the validity information of the line L including the eviction data indicates that the data is invalid, the cache controller 95 determines that a write-back operation is not to be executed.

The cache controller 95 updates the cache memory 901, using the data related to a request for a read operation of the line fill data based on the read operation request extracted from the packet payload PP of the container CT in which it is determined that a cache miss has occurred. Then, the cache controller 95 adds the read data based on the extracted read operation request to the data to be transmitted in order to transmit the read data to the communication device 6.

As illustrated in FIG. 10, in the third operation example of the first embodiment, the cache device 9 receives the communication frame FR4 from the host controller 4. At this time, in the cache device 9, the cache controller 95 determines that a cache miss has occurred for the read operation request to the communication device 6-1 contained in the container CT1 including the cacheable data. The cache controller 95 also determines that the cache is full.

In this case, the communication control unit 94a extracts the read operation request from the container CT1, and sets the container CT1 to the container CT in the empty state. The cache controller 95 selects the eviction data from the data stored in the cache memory 901. The communication control unit 94a inserts the selected eviction data into the container CT1 in the empty state, together with a write operation request, for example. In the third operation example of the first embodiment, the eviction data is written to the communication device 6-2. The communication control unit 94a inserts a write identifier based on the cache device 9 into the container CT1 as the operation identifier of the eviction data. The communication control unit 94a also inserts an identifier indicating that the data is not cacheable into the container CT1 as the cache identifier of the eviction data. The cache controller 95 updates the cache memory 901 using the data related to a request for a read operation of the line fill data based on the read operation request to the communication device 6-1 extracted from the container CT1. In the third operation example of the first embodiment, the line fill data includes data corresponding to the read operation request extracted from the container CT1 of the communication frame FR4, and is data stored in the communication device 6-1.

The communication control unit 94a does not extract data from the containers CT2 to CT4 not including cacheable data. In this manner, the communication frame FR4 is updated. The cache device 9 transmits the updated communication frame FR4 to the communication device 6-1. Then, the cache controller 95 sets the data related to the request for the read operation of the line fill data as data to be transmitted to the communication device 6-1.

In the communication device 6-1, data extraction from the communication frame FR4 and update of the communication frame FR4 are not executed. Then, the communication device 6-1 transmits the communication frame FR4 having the same contents as those of the received communication frame FR4 to the communication device 6-2.

In the communication device 6-2, data of the container CT1 is extracted. The CPU 66 executes a write operation on the flash memory 602 based on the extracted data. Accordingly, the eviction data erased from the cache memory 901 is written to the communication device 6-2. The communication control unit 64 inserts response data into the container CT1. The communication control unit 64 sets the transmission destination information of the container CT1 as the identification information ID0 of the host controller 4. The communication control unit 64 inserts a write identifier based on the cache device 9 into the container CT1 as the operation identifier of the response data.

In the communication device 6-2, as in the communication device 6-2 in the first operation example of the first embodiment, processing on the container CT2 is executed. The communication control unit 64 inserts response data into the container CT2 with setting the transmission destination information as the identification information ID0 of the host controller 4. The communication device 6-2 transmits the updated communication frame FR4 to the communication device 6-3.

The processing on the communication frame FR4 in the communication devices 6-3 and 6-4 are the same as that on the communication frame FR1 in the first operation example of the first embodiment.

The cache device 9 receives the communication frame FR from the communication device 6-4. At this time, if the communication control unit 94b determines that the operation identifier of the data contained in a certain container CT is a write identifier based on the cache device 9, the response data contained in the container CT is extracted. For example, the communication control unit 94b ascertains that the write operation based on the cache device 9 has been executed in the communication device 6 based on the response data and the operation identifier contained in the container CT. The communication control unit 94b sets the container CT as a container CT in the empty state, for example. Accordingly, the response data of the write operation requested by the cache device 9 is not transmitted to the host controller 4.

In the third operation example of the first embodiment, in the cache device 9 that has received the communication frame FR4 from the communication device 6-4, the communication control unit 94b ascertains that the write operation of the eviction data has been executed in the communication device 6-2 based on the response data and the operation identifier contained in the container CT1. The communication control unit 94b sets the container CT1 to be transmitted to the host controller 4 as a container CT in the empty state. Accordingly, the response data for the write operation of the eviction data is not transmitted to the host controller 4. The containers CT2 to CT4 of the communication frame FR4 are not updated. In this manner, the updated communication frame FR4 is transmitted to the host controller 4.

In the third operation example of the first embodiment, as illustrated in FIG. 11, after the transmission of the communication frame FR4, the host controller 4 transmits to the cache device 9, a communication frame FR5 in which the container CT1 is in the empty state, data corresponding to the identification information ID2 (the communication device 6-2) is contained in the container CT2, data corresponding to the identification information ID3 (the communication device 6-3) is contained in the container CT3, and data corresponding to the identification information ID4 (the communication device 6-4) is contained in the container CT4, for example. The containers CT2, CT3, and CT4 contain commands, addresses, and write data for requesting for writing the write data to the communication devices 6-2, 6-3, and 6-4, respectively, for example. The cache identifiers of the data inserted into the containers CT2, CT3, and CT4 are identifiers indicating that the data is not cacheable data. Accordingly, the containers CT2, CT3, and CT4 are containers CT that do not include cacheable data. The operation identifiers of the requests contained in the containers CT2, CT3, and CT4 of the communication frame FR5 transmitted from the host controller 4 are write identifiers based on the host controller 4.

The transmission of the communication frame FR5 from the host controller 4 to the cache device 9 may be executed after the transmission of the communication frame FR4 from the host controller 4 to the cache device 9. The transmission of the communication frame FR5 from the host controller 4 to the cache device 9 can be executed at a timing independent of the processing on the communication frame FR4 in the communication devices 6-1 to 6-4 and the cache device 9.

If the cache device 9 includes data related to a request for a read operation of line fill data based on a request for a read operation by the host controller 4 as data to be transmitted, upon receipt of the communication frame FR including a container CT in the empty state from the host controller 4, the communication control unit 94a inserts the data to be transmitted into the container CT in the empty state. The communication control unit 94a inserts a read identifier based on the host controller 4 into the container CT as an operation identifier of the data to be transmitted. The communication control unit 94a inserts an identifier indicating that the data is cacheable into the container CT as a cache identifier of the data to be transmitted, for example.

In the third operation example of the first embodiment, the communication control unit 94a inserts data (data to be transmitted) related to a request for a read operation of line fill data based on a request for a read operation extracted from the container CT1 of the communication frame FR4, into the container CT1 in the empty state of the communication frame FR5. The communication control unit 94a sets the transmission destination information of the container CT1 as the identification information ID1 of the communication device 6-1 that is the target of the read operation. At the time of insertion of the data to be transmitted, the communication control unit 94a sets the operation identifier of the data to be transmitted as a read identifier based on the host controller 4. The communication control unit 94a sets the cache identifier of the above data as an identifier indicating that the data is cacheable. The communication control unit 94a does not extract data from the containers CT2 to CT4 not including cacheable data. In this manner, the communication frame FR5 is updated. The cache device 9 transmits the updated communication frame FR5 to the communication device 6-1.

The processing on the communication frame FR5 in the communication device 6-1 is similar to the processing on the communication frame FR3 in the communication device 6-1 in the second operation example of the first embodiment. Accordingly, the line fill data read from the communication device 6-1 is inserted into the container CT1 of the communication frame FR5 with the host controller 4 as a transmission destination. In this manner, the communication frame FR5 is updated. The communication device 6-1 transmits the updated communication frame FR5 to the communication device 6-2.

The processing on the communication frame FR5 in the communication devices 6-2 to 6-4 and the processing on the communication frame FR5 transmitted from the communication device 6-4 in the cache device 9 are similar to those on the communication frame FR3 in the second operation example of the first embodiment. Accordingly, the cache memory 901 is updated using the read data (line fill data) read by the communication device 6-1. In addition, the communication frame FR5 including the container CT1 into which the read data has been inserted is transmitted from the cache device 9 to the host controller 4.

This ends the processing of the third operation example of the first embodiment.

As described above, if it is determined that a cache miss has occurred for the request for the read operation to the communication device 6 and that the cache is full, the cache memory 901 is updated based on the requests for an eviction operation of the data and a read operation of the line fill data. The request for a read operation of the line fill data is transmitted to the target communication device 6 using a container CT in the empty state. Then, read data based on read data (line fill data) read from the target communication device 6 is transmitted to the host controller 4.

### 1.2.2.4 Fourth Operation Example of First Embodiment

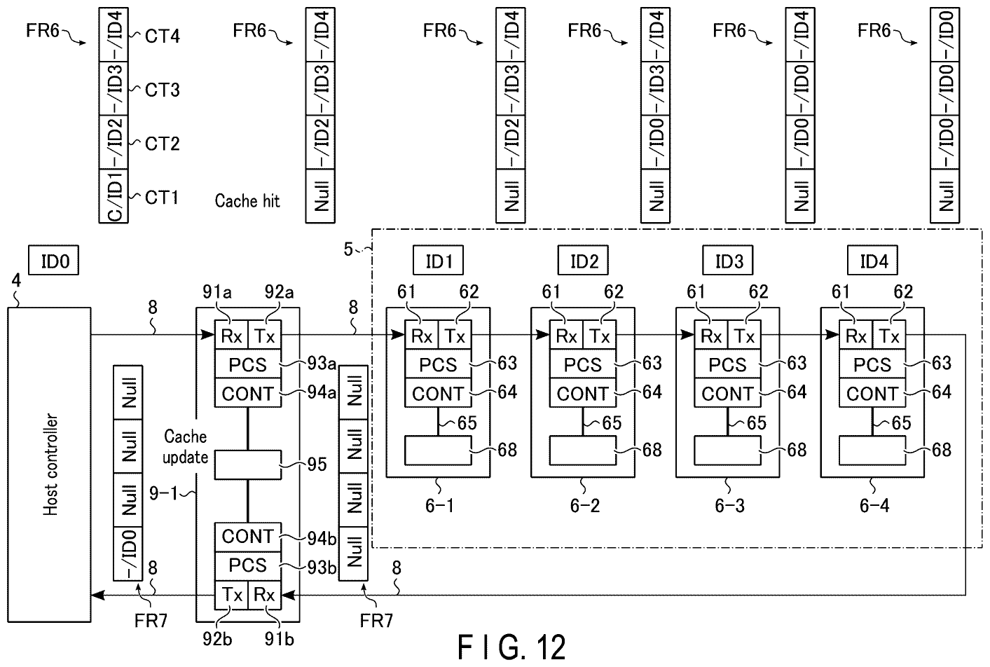

A fourth operation example of the communication system 1 according to the first embodiment will be described with reference to FIG. 12. FIG. 12 is a diagram illustrating the fourth operation example in the communication system according to the first embodiment. Hereinafter, an example of a case where a cache hit occurs for a write operation request will be described as the fourth operation example of the first embodiment with reference to FIG. 12.

For example, the host controller 4 transmits to the cache device 9, a communication frame FR6 in which data corresponding to the identification information ID1 (the communication device 6-1) is contained in the container CT1, data corresponding to the identification information ID2 (the communication device 6-2) is contained in the container CT2, data corresponding to the identification information ID3 (the communication device 6-3) is contained in the container CT3, and data corresponding to the identification information ID4 (the communication device 6-4) is contained in the container CT4. The containers CT1, CT2, CT3, and CT4 contain write data, commands, and addresses for requesting for writing the write data to the communication devices 6-1, 6-2, 6-3, and 6-4, respectively. The cache identifier of the data inserted into the container CT1 is an identifier indicating that the data is cacheable data. Accordingly, the container CT1 is a container CT including cacheable data. The cache identifiers of the data inserted into the containers CT2, CT3, and CT4 are identifiers indicating that the data is not cacheable data. Accordingly, the containers CT2, CT3, and CT4 are containers CT that do not include cacheable data. The operation identifiers of the requests contained in the containers CT1 to CT4 of the communication frame FR6 transmitted from the host controller 4 are write identifiers based on the host controller 4.

At the transmission of the communication frame FR6 from the host controller 4, the cache memory 901 of the cache device 9 stores data that corresponds to write data as the target of the write operation request contained in the container CT1. The data corresponding to the write data is data having the same logical address as that of the write data already stored in the cache memory 901, for example.

If the cache device 9 that has received the communication frame FR from the host controller 4 determines that a cache hit has occurred for the write operation request contained in the container CT, the communication control unit 94a extracts the write operation request from the container CT. If the data included in the container CT is only the write operation request, the communication control unit 94a sets the container CT as a container CT in the empty state, for example. The cache controller 95 updates the cache memory 901 using the data related to the write operation request extracted from the container CT.

The cache controller 95 adds the data related to the write operation request to the data to be transmitted in order to transmit the data to the communication device 6. The write data that is the target of the write operation is written to the communication device 6 that is the target of the write operation by a write-back method, for example. The cache controller 95 adds response data to the write operation to the data to be transmitted in order to transmit the response data to the host controller 4, for example.

Writing by the write-back method will be additionally described. After the data related to the write operation request is set as the data to be transmitted as described above, the cache device 9 receives the communication frame FR including a container CT in the empty state from the host controller 4, for example. At this time, the communication control unit 94a inserts the data to be transmitted into the container CT in the empty state. The communication control unit 94a sets the transmission destination information of the container CT to the communication device 6 that is the target of the write operation. The communication control unit 94a inserts a write identifier based on the cache device 9 into the container CT as the operation identifier of the data to be transmitted, for example. The cache device 9 transmits the communication frame FR updated as described above to the communication device 6-1. As described above, the write operation is executed in the communication device 6 that is the target of the write operation.

In the fourth operation example of the first embodiment, the communication frame FR6 transmitted from the host controller 4 is received. At this time, in the cache device 9, the cache controller 95 determines that a cache hit has occurred for the write operation request to the communication device 6-1 contained in the container CT1 including the cacheable data. The cache controller 95 updates the cache memory 901 using the write operation request, for example. The communication control unit 94a sets the container CT1 as a container CT in the empty state. The communication control unit 94a does not extract data from the containers CT2 to CT4 not including cacheable data. In this manner, the communication frame FR6 is updated. The communication control unit 94a transmits the updated communication frame FR6 to the communication device 6-1.

The cache controller 95 adds the data related to the write operation request inserted into the container CT1 of the communication frame FR6 to the data to be transmitted. Although not illustrated, the cache device 9 transmits the data to be transmitted to the communication device 6-1 using the container CT in the empty state included in the communication frame FR transmitted from the host controller 4 after the communication frame FR6. Accordingly, the write data that is the target of the write operation is written to the communication device 6-1 by the write-back method.

The processing on the communication frame FR6 in the communication devices 6-1 to 6-4 and the processing on the communication frame FR6 transmitted from the communication device 6-4 in the cache device 9 are similar to those on the communication frame FR1 in the first operation example of the first embodiment.

The response data to the write operation request made by the host controller 4 is transmitted to the host controller 4 using the container CT in the empty state included in a communication frame FR7 received from the communication device 6-4, as in the case of transmission of the data to be transmitted using the communication frame FR2 in the first operation example of the first embodiment, after the data related to the write operation request transmitted from the host controller 4 is extracted from the container CT, for example.

This ends the processing of the fourth operation example of the first embodiment.

As described above, if it is determined that a cache hit has occurred when there is a request for a write operation to the communication device 6, the cache memory 901 is updated based on the write data corresponding to the write operation request. In addition, the write data is written to the target communication device 6 by the write-back method.

### 1.2.2.5 Fifth Operation Example of First Embodiment

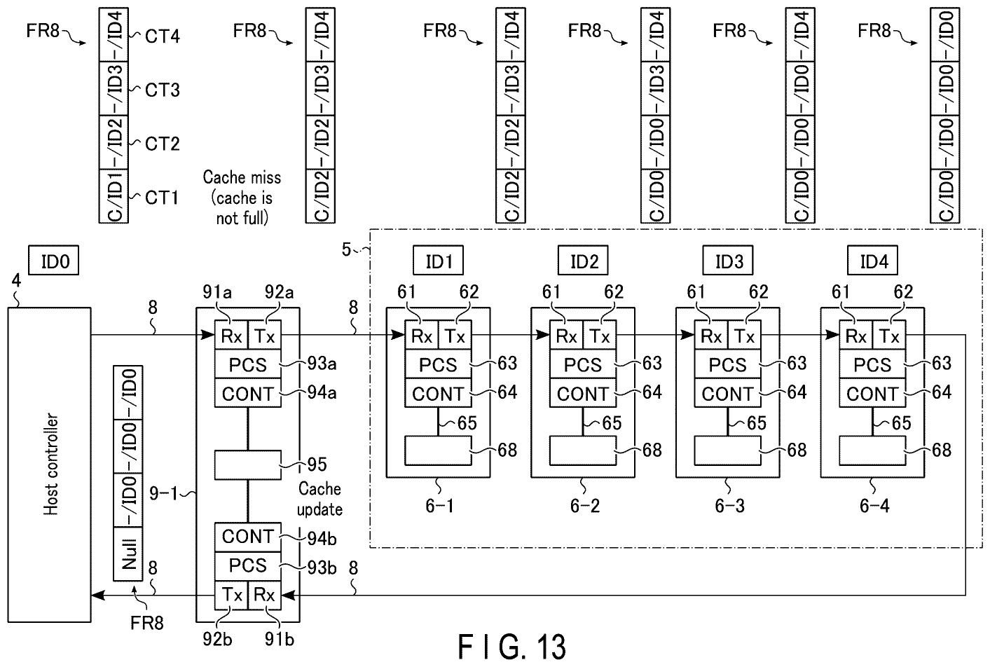

A fifth operation example of the communication system 1 according to the first embodiment will be described with reference to FIG. 13. FIG. 13 is a diagram illustrating the fifth operation example in the communication system according to the first embodiment. Hereinafter, an example of a case where the cache is not full when a cache miss occurs for a write operation request will be described with reference to FIG. 13, as the fifth operation example of the first embodiment.

A communication frame FR8 transmitted from the host controller 4 in the fifth operation example of the first embodiment is similar to the communication frame FR6 transmitted from the host controller 4 in the fourth operation example of the first embodiment.

At the transmission of the communication frame FR8 from the host controller 4, the cache memory 901 of the cache device 9 does not store data that corresponds to write data as the target of the write operation request contained in the container CT1. At this time, an example of a case where the cache is not full will be described.

If the cache device 9 having received the communication frame FR from the host controller 4 determines that a cache miss has occurred for the write operation request contained in the container CT, the cache controller 95 determines whether the cache is full. If it is determined that the cache is not full, the communication control unit 94a extracts the write operation request from the container CT. The communication control unit 94a sets the container CT as a container CT in the empty state, for example. Then, the communication control unit 94a inserts a request for a read operation of line fill data into the container CT that is set to the empty state as described above, for example. The communication control unit 94a inserts a read identifier based on the cache device 9 into the container CT as the operation identifier of the request for the read operation of the line fill data, for example. The communication control unit 94a sets the cache identifier of the request for the read operation of the line fill data as an identifier indicating that the data is not cacheable, for example. The cache controller 95 adds response data to the write operation to the data to be transmitted in order to transmit the response data to the host controller 4, for example.

In the fifth operation example of the first embodiment, the communication frame FR8 transmitted from the host controller 4 is received. At this time, in the cache device 9, the cache controller 95 determines that a cache miss has occurred for the write operation request to the communication device 6-1 contained in the container CT1. The cache controller 95 also determines that the cache is not full. The communication control unit 94a extracts data related to the write operation request from the container CT1. The communication control unit 94a sets the container CT1 as a container CT in the empty state. Then, the communication control unit 94a inserts data related to a request for a read operation of line fill data from the communication device 6-2 into the container CT1 in the empty state, for example. In the fifth operation example of the first embodiment, the line fill data includes data corresponding to the write operation request extracted from the container CT1 of the communication frame FR8, and is data stored in the communication device 6-2. The communication control unit 94a inserts a read identifier based on the cache device 9 into the container CT1 as the operation identifier of the read operation request. The communication control unit 94a also sets the cache identifier of the read operation request as an identifier indicating that the data is cacheable. The communication control unit 94a does not extract data from the containers CT2 to CT4 not including cacheable data. In this manner, the communication frame FR8 is updated. The communication control unit 94a transmits the updated communication frame FR8 to the communication device 6-1.

In the communication device 6-1, processing on the communication frame FR8 is not executed.

In the communication device 6-2, data of the container CT1 is extracted. The CPU 66 executes a read operation of the line fill data on the flash memory 602 based on the extracted data. The communication control unit 64 inserts the read line fill data into the container CT1. The communication control unit 64 sets the transmission destination information of the container CT1 as the identification information ID0 of the host controller 4. The communication control unit 64 inserts a read identifier based on the cache device 9 into the container CT1 as the operation identifier of the line fill data. The communication control unit 94a sets the above cache identifier of the line fill data as an identifier indicating that the data is cacheable.

In the communication device 6-2, as in the communication device 6-2 in the first operation example of the first embodiment, processing on the container CT2 is executed. The communication device 6-2 transmits the updated communication frame FR8 to the communication device 6-3.

The processing on the communication frame FR8 in the communication devices 6-3 and 6-4 is similar to that on the communication frame FR1 in the first operation example of the first embodiment and that on the communication frame FR6 in the fourth operation example of the first embodiment.

The cache device 9 receives the communication frame FR from the communication device 6-4. At this time, if the communication control unit 94b determines that the operation identifier of the data contained in a certain container CT is a read identifier based on the cache device 9, the read data (line fill data) is extracted from the container CT. For example, the cache controller 95 overwrites the extracted line fill data with write data for which a write operation is requested by the host controller 4. The cache controller 95 updates the cache memory 901 based on the write data after overwriting. The communication control unit 94b sets the container CT as a container CT in the empty state, for example. Accordingly, the line fill data read in response to the request from the cache device 9 is not transmitted to the host controller 4.

In the fifth operation example of the first embodiment, in the cache device 9 that has received the communication frame FR8 from the communication device 6-4, the communication control unit 94b extracts the line fill data read from the communication device 6-2 from the container CT1. The cache controller 95 overwrites the line fill data with the write data transmitted from the host controller 4. Then, the cache memory 901 is updated based on the write data after overwriting. The communication control unit 94b sets the container CT1 to be transmitted to the host controller 4 as a container CT in the empty state. The containers CT2 to CT4 of the communication frame FR8 are not updated. In this manner, the updated communication frame FR8 is transmitted to the host controller 4.

If the cache device 9 determines that a cache miss has occurred for the write operation request, the write data that is the target of the write operation is managed in the cache memory 901 by a write allocation method, for example. In the write allocation method, in response to a write operation request to the communication device 6, line fill data is read from the communication device 6 to the cache memory 901 in units of the size of the line L, for example. The read data of the line L is overwritten with write data transmitted from the host controller 4. Then, the write operation of the overwritten data is executed by the write-back method.

Although not illustrated in FIG. 13, the response data to the write operation request made by the host controller 4 is transmitted to the host controller 4 using the container CT in the empty state received from the communication device 6-4 after data related to the write operation request transmitted from the host controller 4 is extracted from the container CT, as in the fourth operation example of the first embodiment, for example.

This ends the processing of the fifth operation example of the first embodiment.

As described above, if it is determined that a cache miss has occurred and the cache is not full when there is a request for a write operation to the communication device 6, the cache memory 901 is updated based on the write data corresponding to the write operation request. In addition, the write data is written to the target communication device 6 by the write-back method.

### 1.2.2.6 Sixth Operation Example of First Embodiment

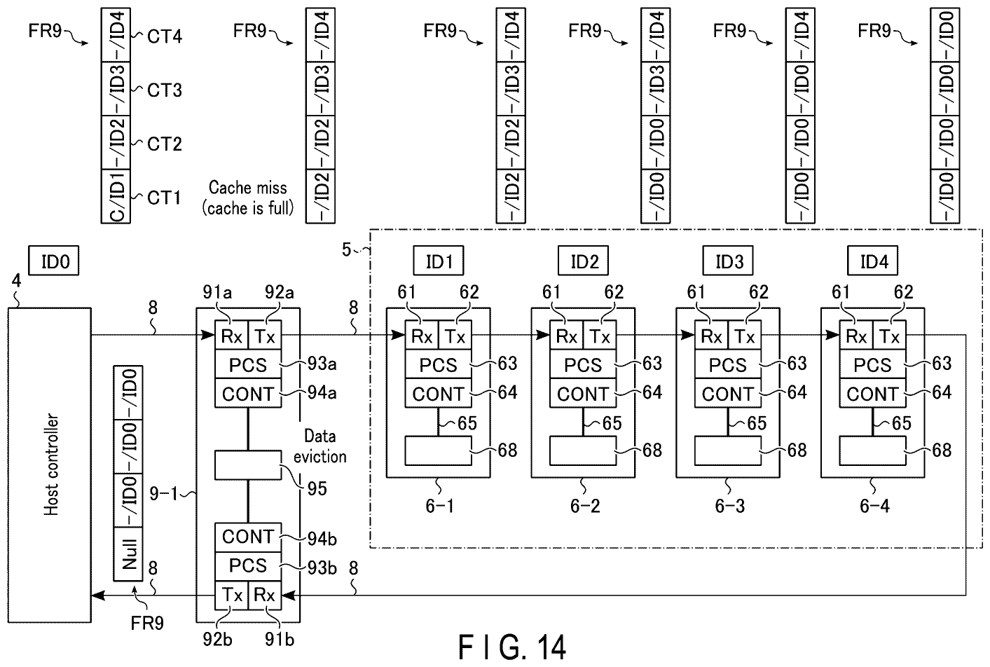

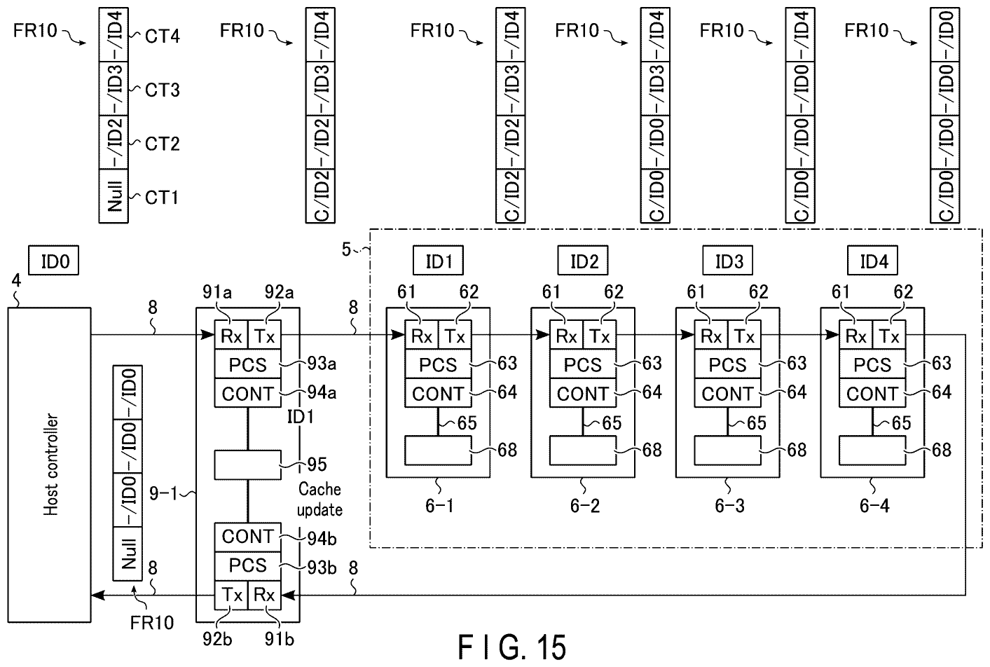

A sixth operation example of the communication system 1 according to the first embodiment will be described with reference to FIGS. 14 and 15. FIGS. 14 and 15 are diagrams illustrating the sixth operation example in the communication system according to the first embodiment. Hereinafter, an example of a case where the cache is full when a cache miss occurs for a write operation request will be described with reference to FIGS. 14 and 15 as the sixth operation example of the first embodiment.

A communication frame FR9 transmitted from the host controller 4 in the sixth operation example of the first embodiment is similar to the communication frames FR6 and FR8 transmitted from the host controller 4 in the fourth operation example and the fifth operation example of the first embodiment.

At the transmission of the communication frame FR9 from the host controller 4, the cache memory 901 of the cache device 9 does not store data that corresponds to write data as the target of the write operation request contained in the container CT1. At this time, an example of a case where the cache is full will be described.

If the cache device 9 that has received the communication frame FR from the host controller 4 determines that a cache miss has occurred for the write operation request contained in the container CT and that the cache is full, the communication control unit 94a extracts the write operation request from the container CT as in the third operation example of the first embodiment. If the data included in the container CT is only the write operation request, the communication control unit 94a sets the container CT as a container CT in the empty state, for example. The cache controller 95 executes an eviction operation based on the write operation request. The eviction operation is substantially the same as the eviction operation based on the read operation request in the third operation example of the first embodiment. Accordingly, the eviction data is erased from the cache memory 901, and the free space of the cache memory 901 is secured. As in the third operation example of the first embodiment, the eviction data may be written to the communication device 6 in addition to the erase of the eviction data. That is, the write-back operation based on the write operation request may be executed. The write-back operation is also substantially the same as the write-back operation based on the read operation request in the third operation example of the first embodiment.

The cache controller 95 adds the data related to the write operation request to the data to be transmitted in order to transmit the data to the communication device 6. The cache controller 95 adds response data to the write operation request to the data to be transmitted in order to transmit the response data to the host controller 4, for example.

As illustrated in FIG. 14, in the sixth operation example of the first embodiment, the cache device 9 receives the communication frame FR9 from the host controller 4. At this time, in the cache device 9, the cache controller 95 determines that a cache miss has occurred for the write operation request to the communication device 6-1 contained in the container CT1. The cache controller 95 also determines that the cache is full. In this case, as in the fourth operation example and the fifth operation example of the first embodiment, the communication control unit 94a extracts the write operation request from the container CT1 and sets the container CT1 as a container CT in the empty state. The cache controller 95 selects the eviction data from the data stored in the cache memory 901. The communication control unit 94a inserts the selected eviction data into the container CT1 in the empty state, together with a write operation request, for example. The communication control unit 94a inserts a write identifier based on the cache device 9 into the container CT1 as the operation identifier of the eviction data. The communication control unit 94a sets the cache identifier of the eviction data as an identifier indicating that the data is not cacheable. In the sixth operation example of the first embodiment, the eviction data is written to the communication device 6-2. The communication control unit 94a does not extract data from the containers CT2 to CT4 not including cacheable data. In this manner, the communication frame FR9 is updated. The cache device 9 transmits the updated communication frame FR9 to the communication device 6-1.

The processing on the communication frame FR9 in the communication devices 6-1 to 6-4 and the processing on the communication frame FR9 transmitted from the communication device 6-4 in the cache device 9 are similar to those on the communication frame FR4 in the third operation example of the first embodiment. Accordingly, the response data for the write operation request of the eviction data is not transmitted to the host controller 4.

In the sixth operation example of the first embodiment, as illustrated in FIG. 15, after the transmission of the communication frame FR9, the host controller 4 transmits to the cache device 9, a communication frame FR10 in which the container CT1 is in the empty state, data corresponding to the identification information ID2 (the communication device 6-2) is contained in the container CT2, data corresponding to the identification information ID3 (the communication device 6-3) is contained in the container CT3, and data corresponding to the identification information ID4 (the communication device 6-4) is contained in the container CT4, for example. The containers CT2, CT3, and CT4 contain commands, addresses, and write data for requesting for writing the write data to the communication devices 6-2, 6-3, and 6-4, respectively, for example. The cache identifiers of the data inserted into the containers CT2, CT3, and CT4 are identifiers indicating that the data is not cacheable data. Accordingly, the containers CT2, CT3, and CT4 are containers CT that do not include cacheable data. The operation identifiers of the requests contained in the containers CT2, CT3, and CT4 of the communication frame FR10 transmitted from the host controller 4 are write identifiers based on the host controller 4.

The transmission of the communication frame FR10 from the host controller 4 to the cache device 9 may be executed after the transmission of the communication frame FR9 from the host controller 4 to the cache device 9. The transmission of the communication frame FR10 from the host controller 4 to the cache device 9 can be executed at a timing independent of the processing on the communication frame FR9 in the communication devices 6-1 to 6-4 and the cache device 9.

In the sixth operation example of the first embodiment, the communication control unit 94a inserts a request for a read operation of line fill data into the container CT1 in the empty state of the communication frame FR10. In the sixth operation example of the first embodiment, the line fill data includes data corresponding to the write operation request extracted from the container CT1 of the communication frame FR9, and is data stored in the communication device 6-2. The communication control unit 94a sets the transmission destination information of the container CT1 as the identification information ID2 of the communication device 6-2 that is the target of the write operation. The communication control unit 94a inserts a read identifier based on the cache device 9 into the container CT1 as the operation identifier of the request for the read operation of the line fill data, for example. The communication control unit 94a sets the cache identifier of the above data as an identifier indicating that the data is cacheable.

The communication control unit 94a does not extract data from the containers CT2 to CT4 not including cacheable data. In this manner, the communication frame FR10 is updated. The cache device 9 transmits the updated communication frame FR10 to the communication device 6-1.

The processing on the communication frame FR10 in the communication devices 6-1 to 6-4 and the processing on the communication frame FR10 transmitted from the communication device 6-4 in the cache device 9 are similar to those on the communication frame FR8 in the fifth operation example of the first embodiment. Accordingly, the cache controller 95 overwrites the line fill data read by the communication device 6-2 with the write data extracted from the container CT1 of the communication frame FR9. The cache memory 901 is updated using the write data after overwriting. The container CT1 transmitted to the host controller 4 is set as a container CT in the empty state. Accordingly, the line fill data read in response to the request from the cache device 9 is not transmitted to the host controller 4.

If it is determined that a cache miss has occurred for the write operation request as described above, the write data that is the target of the write operation is managed by the write allocation method. Then, the write operation of the plurality of data with the size of the line L including the line fill data overwritten with the write data is executed by the write-back method.

Although not illustrated in FIGS. 14 and 15, the response data to the write operation requested by the host controller 4 is transmitted to the host controller 4 using the container CT in the empty state received from the communication device 6-4 after data related to the write operation request transmitted from the host controller 4 is extracted from the container CT, as in the fourth operation example and the fifth operation example of the first embodiment, for example.

This ends the processing of the sixth operation example of the first embodiment.

As described above, if it is determined that a cache miss has occurred and the cache is full when there is a request for a write operation to the communication device 6, the free space of the cache memory 901 is secured. In addition, the cache memory 901 is updated based on the write data corresponding to the write operation request. The write data is written to the target communication device 6 by the write-back method.

### 1.2.2.7 Seventh Operation Example of First Embodiment

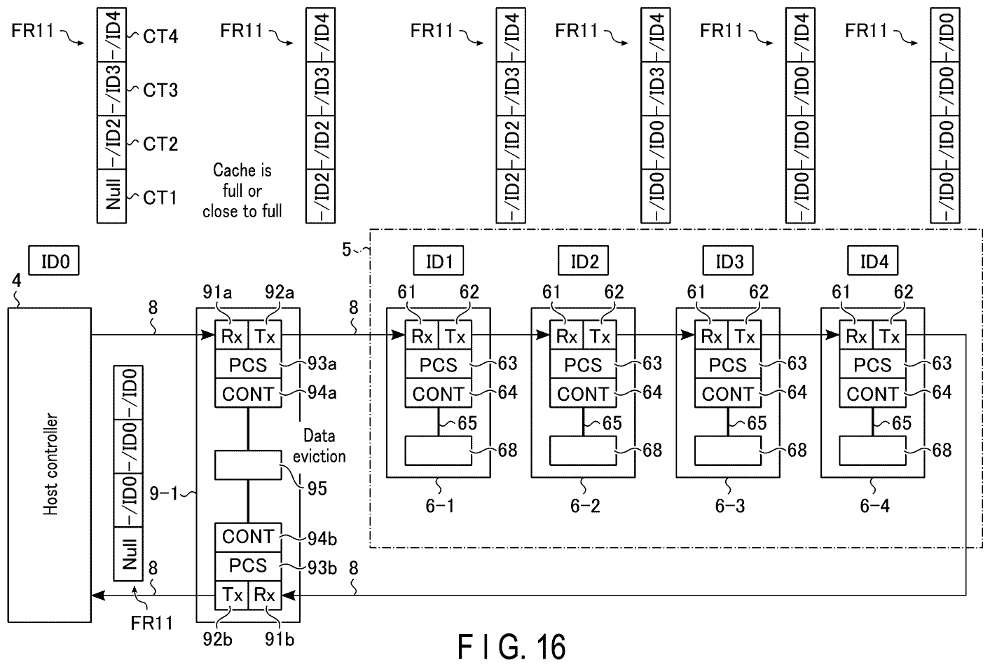

A seventh operation example of the communication system 1 according to the first embodiment will be described with reference to FIG. 16. FIG. 16 is a diagram illustrating the seventh operation example in the communication system according to the first embodiment. As the seventh operation example of the communication system 1 according to the first embodiment, an example of a case in which an eviction operation is executed when the cache is full or when the cache is close to full will be described with reference to FIG. 16.

A communication frame FR11 transmitted from the host controller 4 in the seventh operation example of the first embodiment is similar to the communication frame FR5 transmitted from the host controller 4 in the third operation example of the first embodiment. That is, the communication frame FR11 includes a container CT1 in the empty state.

The cache controller 95 determines whether the cache is full or close to full, for example. If it is determined that the cache is full or close to full, the cache controller 95 executes an eviction operation, as in the third operation example and the sixth operation example of the first embodiment, upon receipt of the communication frame FR including the container CT in the empty state from the host controller 4. Accordingly, the eviction data is erased from the cache memory 901, and the free space of the cache memory 901 is secured. As in the third operation example and the sixth operation example of the first embodiment, the eviction data may be written to the communication device 6 in addition to the erase of the eviction data. That is, the write-back operation based on the state of the cache memory 901 may be executed. After the eviction data is erased from the cache memory 901, the cache controller 95 updates the cache memory 901.

In the seventh operation example of the first embodiment, the cache controller 95 determines that the cache is full or close to full. The cache controller 95 selects eviction data. When the cache device 9 receives the communication frame FR11 including the container CT1 in the empty state from the host controller 4, the communication control unit 94a inserts the eviction data into the container CT1 together with the write operation request. The communication control unit 94a inserts a write identifier based on the cache device 9 into the container CT1 as the operation identifier of the request for the write operation of the eviction data, for example. The communication control unit 94a does not extract data from the containers CT2 to CT4 not including cacheable data. In this manner, the communication frame FR11 is updated. The cache device 9 transmits the updated communication frame FR11 to the communication device 6-1. After the eviction data is erased from the cache memory 901, the cache controller 95 updates the cache memory 901.

The processing on the communication frame FR11 in the communication devices 6-1 to 6-4 and the processing on the communication frame FR11 transmitted from the communication device 6-4 in the cache device 9 are similar to those on the communication frame FR4 in the third operation example of the first embodiment and those on the communication frame FR9 in the sixth operation example of the first embodiment. Accordingly, the response data for the write operation of the eviction data is not transmitted to the host controller 4.

This ends the processing of the seventh operation example of the first embodiment.

As described above, if the cache is full or close to full, the free space of the cache memory 901 is secured.

### 1.2.2.8 Eighth Operation Example of First Embodiment

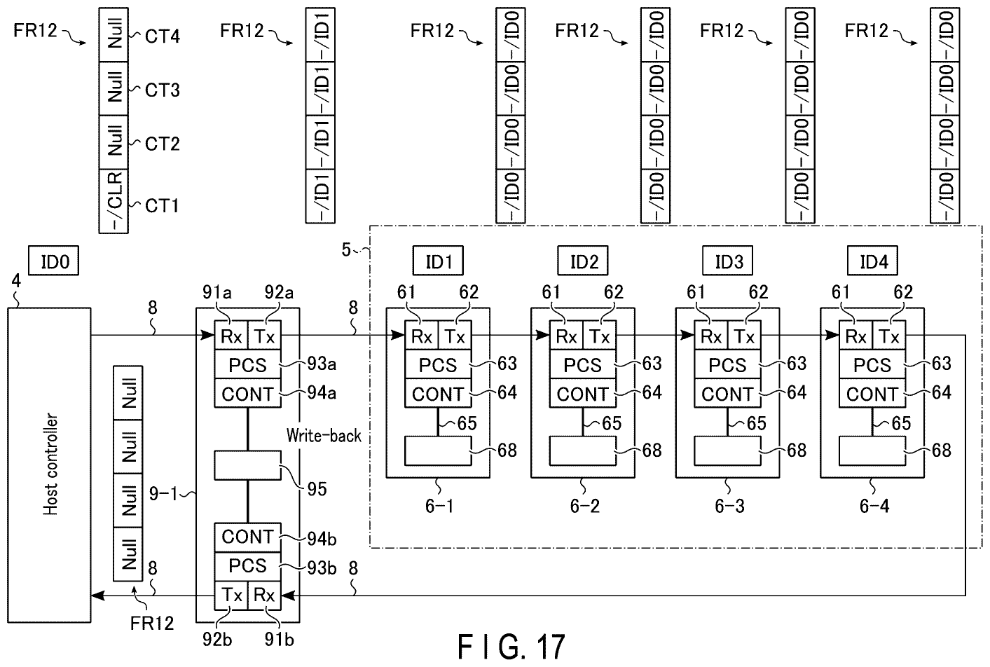

An eighth operation example of the communication system 1 according to the first embodiment will be described with reference to FIG. 17. FIG. 17 is a diagram illustrating the eighth operation example in the communication system according to the first embodiment. In the eighth operation example of the first embodiment, the cache device 9 writes the data stored in the cache memory 901 back to the communication device 6 in response to a cache clear command.

In the eighth operation example of the first embodiment, the host controller 4 transmits a communication frame FR in which the cache clear command is stored in the container CT1 and the containers CT2 to CT4 are in the empty state to the cache device 9, for example. The container CT1 does not include transmission destination information, for example. In the host controller 4, the communication control unit 44 sets the container CT in which the cache clear command is stored as a container CT that does not include cacheable data, for example. In the drawing, the sign “CLR” is attached to the container CT in which the cache clear command is stored.

In the cache device 9 that has received the communication frame FR transmitted from the host controller 4, the communication control unit 94a of the cache device 9 can determine whether the cache clear command is included in the packet header PH of the container CT. If it is determined that the cache clear command is included, the cache controller 95 sets the container CT as a container CT in the empty state. The communication control unit 94a executes the write-back operation based on the cache clear command. The cache device 9 performs processing on the container CT determined not to include the cache clear command, in the same manner as the processing described above in the first operation example to the seventh operation example of the first embodiment. In FIG. 17, the write-back operation based on the cache clear command is simply described as “write-back”.

In the write-back operation based on the cache clear command, for example, the cache controller 95 adds each piece of data of the line L for which the write-back operation needs to be executed (indicating that the write-back information is in the “Dirty state”) among the data stored in the cache memory 901, as write-back data, to the data to be transmitted. The communication control unit 94a inserts the request for the write operation of each write-back data into the container CT in the empty state, with the communication device 6 that is the target of the write operation as the transmission destination. The communication control unit 94a inserts the write identifier of the write-back data based on the cache device 9 into the container CT, as the operation identifier of the request for the write operation of the write-back data, for example. Thereafter, the cache controller 95 erases the write-back data inserted into the container CT from the cache memory 901.

The cache controller 95 may set not only the data of the line L for which the write-back operation needs to be executed but also all the data stored in the cache memory 901 as the write-back data. In this case, all the data is written back to the communication device 6. In addition, the data of all the lines L is erased from the cache memory 901.

In the eighth operation example of the first embodiment, the communication control unit 94a determines that the cache clear command is included in the container CT1. The cache controller 95 sets the container CT1 as a container CT in the empty state. In the eighth operation example of the first embodiment, the cache controller 95 selects four pieces of write-back data. The communication control unit 94a inserts the selected four pieces of write-back data into the containers CT1 to CT4 of a communication frame FR12. The communication control unit 94a inserts the write identifier of the write-back data based on the cache device 9 into each of the containers CT1 to CT4 as the operation identifier of the request for the write operation of the write-back data. In this manner, the communication frame FR12 is updated. The updated communication frame FR12 is transmitted to the communication device 6-1. In the eighth operation example of the first embodiment, the selected four pieces of write-back data are written to the communication device 6-1.

In the communication device 6-1, data of the containers CT1 to CT4 is extracted, and a write operation using data inserted into each container CT is executed. In addition, response data of the write operation is inserted into the containers CT1 to CT4 with the identification information ID0 of the host controller 4 as transmission destination information. At this time, the communication control unit 64 maintains the operation identifier of the response data inserted into the containers CT1 to CT4 as the write identifier of the write-back data based on the cache device 9. In this manner, the communication frame FR12 is updated. The updated communication frame FR12 is transmitted to the communication device 6-2.

In the communication device 6-2 to 6-4, data extraction from the communication frame FR12 and update of the communication frame FR12 are not executed.

In the cache device 9, the communication control unit 94b ascertains that the write operation of the write-back data is executed in the communication device 6-1 based on the response data and the operation identifier, for example. The communication control unit 94b sets the containers CT1 to CT4 to be transmitted to the host controller 4 as containers CT in the empty state. Accordingly, the response data for the write operation of the write-back data is not transmitted to the host controller 4. In this manner, the updated communication frame FR12 is transmitted to the host controller 4.

Upon ascertaining that the write operation of all the write-back data to the communication device 6 has been completed, the cache device 9 transmits a write-back completion notification to the host controller 4 using the container CT in the empty state transmitted from the communication device 6-4, for example.

This ends the processing of the eighth operation example of the first embodiment.

As described above, when the container CT including the cache clear command is transmitted from the host controller 4, the data stored in the cache memory 901 is written back to the communication device 6.

### 1.3 Advantageous Effects

The communication system 1 according to the first embodiment makes it possible to suppress an increase in latency. Hereinafter, advantageous effects of the communication system 1 according to the first embodiment will be described.

The communication system 1 according to the first embodiment includes the host controller 4, the communication devices 6-1 to 6-4, the cache devices 9, and the communication paths 8 capable of transmitting the communication frame FR of a serial signal. The communication paths 8 couple the host controller 4 and the cache devices 9, and couple the cache devices 9 and the communication devices 6-1 to 6-4 in a ring shape. Each cache device 9 includes the reception units 91a and 91b, the transmission units 92a and 92b, the communication control units 94a and 94b, and the cache memory 901. The reception unit 91a receives the communication frame FR from the host controller 4. The communication control unit 94a is capable of data insertion and extraction into and from at least one of the plurality of containers CT. The transmission unit 92a transmits the communication frame FR based on the result of processing by the communication control unit 94a to the communication device 6-1. The reception unit 91b receives the communication frame FR from the communication device 6-4. The communication control unit 94b is configured to be capable of data insertion and extraction into and from at least one of the plurality of containers CT. The transmission unit 92b transmits the communication frame FR based on the result of processing by the communication control unit 94b to the host controller 4.

With the configuration of the communication system 1 according to the first embodiment as described above, the cache memory 901 of each cache device 9 can store in advance read data to be a target of a read operation to the communication device 6, for example. Accordingly, when the host controller 4 transmits a request for a read operation to the communication device 6, the read data stored in the cache memory 901 can be transmitted to the host controller 4, instead of transmitting the read data stored in the communication device 6 to the host controller 4. That is, the read operation in the communication device 6 can be omitted. This reduces processing in the communication device 6. Further, in the communication system 1, the cache memory 901 of each cache device 9 can store write data that is the target of a write operation to the communication device 6, for example. Accordingly, the write operation can be executed by the write-back method, for example. This makes it possible to suppress the occurrence of delay in processing due to the write operation in the communication device 6. Therefore, from the above, an increase in latency can be suppressed.

### 2 Modification of First Embodiment

Next, modifications of the first embodiment will be described.

In the first embodiment described above, the cache device does not include a CPU as an example. However, the present invention is not limited to this example. The cache device may include a CPU.

A communication system 1 according to a modification of the first embodiment includes a system board 2, a connector 3, a host controller 4, a device board 5, a substrate 7, a plurality of communication paths 8, and a plurality of cache devices 9A. The configurations of the system board 2, the connector 3, the host controller 4, the device board 5, the substrate 7, and the plurality of communication paths 8 according to the modification of the first embodiment can be similar to those according to the first embodiment. Hereinafter, the configuration of each cache device 9A according to the modification of the first embodiment will be mainly described in terms of differences from the configuration of each cache device according to the first embodiment.

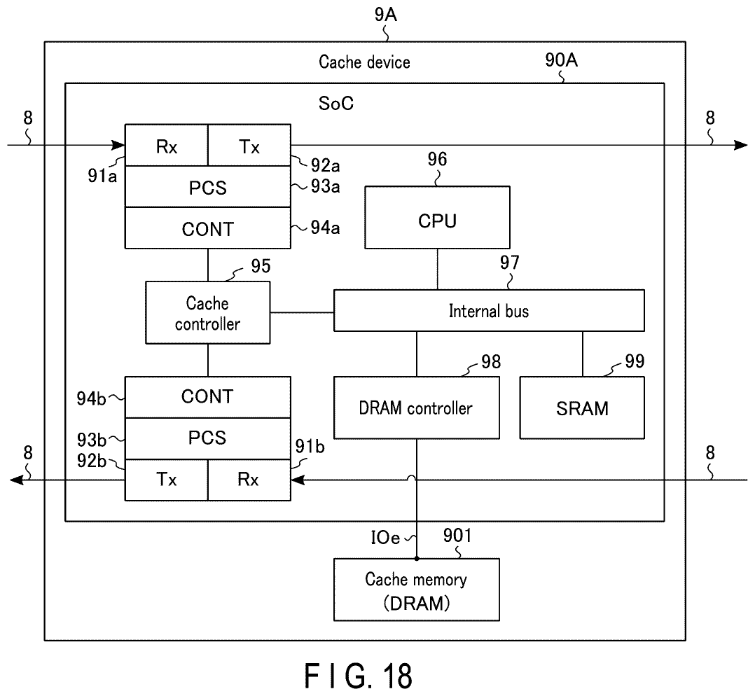

The configuration of each cache device 9A will be described with reference to FIG. 18. FIG. 18 is a block diagram of a cache device included in the communication system according to the modification of the first embodiment.

Each cache device 9A includes a circuit 90A and a cache memory 901. In the modification of the first embodiment, the cache memory 901 is provided outside the circuit 90A. However, the present invention is not limited to this example. The cache memory 901 may be included in the circuit 90A like the cache memory 901 according to the first embodiment. The cache memory 901 is a DRAM, for example. The cache memory 901 may be an SRAM.

The circuit 90A includes reception units 91a and 91b, transmission units 92a and 92b, protocol conversion units 93a and 93b, communication control units 94a and 94b, cache controller 95, a CPU 96, an internal bus 97, a DRAM controller 98, and an SRAM 99. The cache controller 95, the CPU 96, the DRAM controller 98, and the SRAM 99 are coupled to one another by the internal bus 97. In the modification of the first embodiment, the upper layer of the cache device 9 includes the cache controller 95, the CPU 96, the internal bus 97, the DRAM controller 98, the SRAM 99, and the cache memory 901, for example.

The cache controller 95 requests the CPU 96 to control the cache memory 901 based on the communication frame received by the reception unit 91.

The CPU 96 is a processor. The CPU 96 controls the entire operation of the cache device 9A. The CPU 96 controls the DRAM controller 98 and the SRAM 99 via the internal bus 97. For example, the CPU 96 controls the DRAM controller 98 to transmit and receive data to and from the cache memory 901 in response to a request from the cache controller 95.

The DRAM controller 98 controls the cache memory 901 based on a request from the CPU 96. The DRAM controller transmits and receives data to and from the cache memory 901 via a signal line IOe.

The SRAM 99 is a volatile memory. If the cache memory 901 is a DRAM, the cache device 9A may include, instead of the SRAM 99, another memory having an access speed higher than that of the cache memory 901. The SRAM 99 can be used as a work area of the CPU 96.

The operation of the communication system 1 according to the modification of the first embodiment can be substantially similar to the operation of the communication system 1 according to the first embodiment.

The modification of the first embodiment also produces the same advantageous effects as those of the first embodiment.

### 3 Second Embodiment

In the first embodiment and the modification of the first embodiment, the cache device is provided between the host controller and the device board as an example, but the present invention is not limited to this example. A cache unit including a cache memory may be provided in a host controller. In addition, data may be stored in the cache memory in response to an operation request from an external apparatus. Hereinafter, regarding a second embodiment, description of configurations equivalent to those of the first embodiment will be omitted or simplified, and configurations different from those of the first embodiment and operation examples of the communication system will be mainly described.

### 3.1 Configuration of Communication System

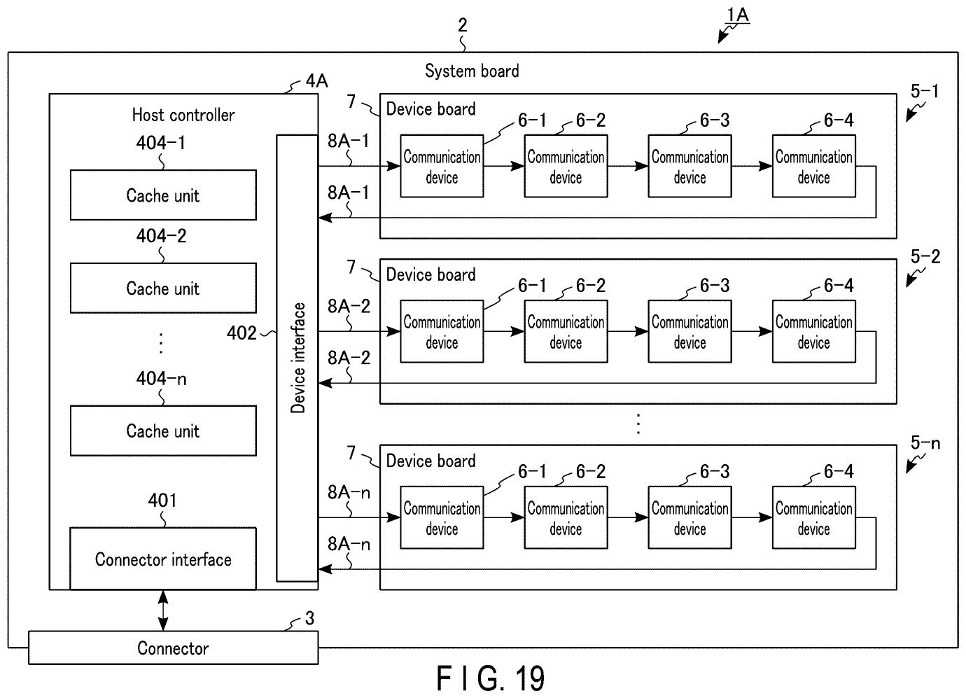

An example of a configuration of a communication system 1A will be described with reference to FIG. 19. FIG. 19 is a block diagram illustrating an overall configuration of the communication system according to the second embodiment.

The communication system 1A includes a system board 2, a connector 3, a host controller 4A, a plurality of device boards 5, and a plurality of communication paths 8A. The configurations of the system board 2, the connector 3, and the plurality of device boards 5 according to the second embodiment are substantially similar to those according to the first embodiment and the modification of the first embodiment. The communication system 1A according to the second embodiment includes n communication paths 8A-1 to 8A-n respectively corresponding to n device boards 5-1 to 5-n. Hereinafter, the configurations of the host controller 4A and the plurality of communication paths 8A in the communication system 1A according to the second embodiment will be mainly described.

The host controller 4A includes a connector interface 401, a device interface 402, and a plurality of cache units 404. In the example illustrated in FIG. 19, the host controller 4A includes n cache units 404-1 to 404-n respectively corresponding to the n device boards 5-1 to 5-n. A more detailed configuration of the host controller 4A will be described later.

Each of the communication paths 8A couples the device interface 402 and communication devices 6-1 to 6-4 included in the device board 5 corresponding to the communication path 8A by ring connection. More specifically, the data output terminal of the device interface 402, the input terminals and the output terminals of the communication device 6-1, the communication device 6-2, the communication device 6-3, and the communication device 6-4, and the data input terminal of the device interface 402 are coupled in a ring shape via the communication path 8A.

### 3.2 Configuration of Host Controller

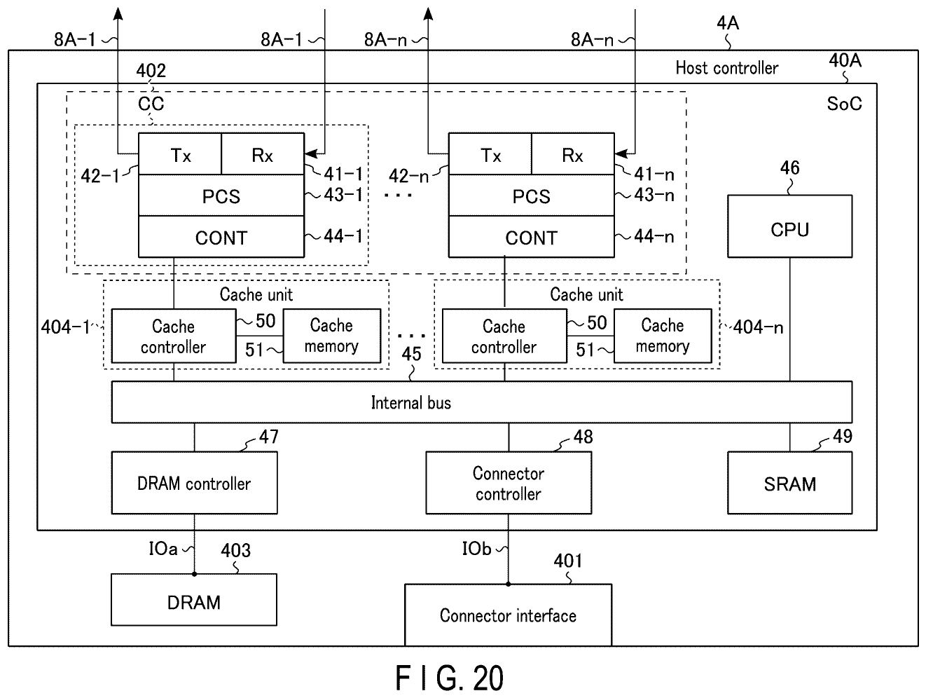

A configuration of the host controller 4A will be described with reference to FIG. 20. FIG. 20 is a block diagram illustrating an example of the host controller included in the communication system according to the second embodiment.

In the host controller 4A, an internal bus 45, a CPU 46, a DRAM controller 47, a connector controller 48, an SRAM 49, the device interface 402, and the plurality of cache units 404 are included in a circuit 40A. The CPU 46, the DRAM controller 47, the connector controller 48, the SRAM 49, and the cache units 404 are coupled to one another by an internal bus 45.

In the device interface 402, a reception unit 41 receives a communication frame FR from the communication device 6-4 via the communication path 8A. A transmission unit 42 transmits the communication frame FR to the communication device 6-1 via the communication path 8A. A communication control unit 44 is coupled to the internal bus 45 via the corresponding cache unit 404.

The CPU 46 controls the DRAM controller 47, the connector controller 48, the SRAM 49, and each cache unit 404 via the internal bus 45.

The n cache units 404-1 to 404-n correspond to the n device boards 5-1 to 5-n, respectively. Each cache unit 404 includes a cache controller 50 and a cache memory 51.

In each cache unit 404, the cache controller 50 is coupled to the communication control unit 44 of the corresponding one of n chain controllers CC. The cache controller 50 is coupled to the internal bus 45. Accordingly, the communication control unit 44 and the internal bus 45 are coupled via the cache controller 50. In addition, the cache controller 50 and the cache memory 51 are coupled to each other.

The cache controller 50 controls the cache memory 51 based on an operation request received by the connector interface 401 from an external apparatus, for example. The cache controller 50 also transmits and receives data to and from the cache memory 51.

The cache controller 50 can determine whether a cache hit occurs upon receipt of a request for a read operation or a write operation from an external apparatus, for example. The cache hit in the second embodiment means that the data to be subjected to these operations (read data or write data) is stored in the cache memory 51, for example.

The cache controller 50 also estimates one or more pieces of data accessed after the operation request received from the external apparatus or an address of the one or more pieces of data based on an access pattern from the external apparatus to the communication system 1A. In other words, the cache controller 50 estimates data that is the target of the read operation request or the write operation request after the operation request received from the external apparatus, for example. In the following description, each of the one or more pieces of data will be referred to as prefetch data. The access pattern refers to an access method such as sequential access, for example. The cache controller 50 updates the cache memory 51 using the estimated prefetch data. The number of pieces of prefetch data estimated by the cache controller 50 can be determined according to the length of the communication path 8A or the number of communication devices 6, for example.

The cache memory 51 is a volatile memory. The cache memory 51 is an SRAM, for example. The cache memory 51 is also simply called a memory. The host controller 4A may include, instead of the cache memory 51, another volatile memory or non-volatile memory controlled by the cache controller 50. The cache memory 51 may be provided outside the circuit 40A.

### 3.3 Configuration of Communication Frame

An example of a configuration of the communication frame FR according to the second embodiment will be described.

The configurations of a packet payload PP, a PP identifier, and a cache identifier in each container CT of the communication frame FR are similar to those in the first embodiment. Hereinafter, an operation identifier in the second embodiment will be described.

In the second embodiment, the operation identifier is an identifier for identifying what kind of operation request, if any, is included in the container CT, for example. The operation identifier is also an identifier for identifying, if the container CT includes data indicating response data or read data, from what operation the data results, for example. If the container CT includes data indicating response data or read data, the operation identifier is configured to be capable of identifying an address of the communication device 6 corresponding to the data, for example.

### 3.4 Operations

Next, operations of the communication system 1A according to the second embodiment will be described. Hereinafter, the operations of the host controller 4A including the cache units 404 according to the second embodiment will be described using a plurality of operation examples in the communication system 1A according to the second embodiment.

In the drawings described below, the identification information of the host controller 4A is referred to as identification information ID0A.

### 3.4.1 Overall Operations

First to fourth operation examples of the communication system 1A according to the second embodiment will be described. Hereinafter, the operations of the host controller 4A including the cache units 404 will be specifically described using the first to fourth operation examples of the second embodiment.

As the first operation example of the second embodiment, an operation example of a case in which a cache hit occurs for a read operation request received from an external apparatus will be described. As the second operation example of the second embodiment, an operation example of a case in which a cache miss occurs for a read operation request received from an external apparatus will be described. As the third operation example of the second embodiment, an operation example of a case in which a cache hit occurs for a write operation request received from an external apparatus will be described. As the fourth operation example of the second embodiment, an operation example of a case in which a cache miss occurs for a write operation request received from an external apparatus will be described.

In the drawings illustrating these operation examples, the internal bus 45, the CPU 46, the DRAM controller 47, the connector controller 48, the SRAM 49, the connector interface 401, and the DRAM 403 in the host controller 4A are not illustrated. In the drawings described below, only one of the plurality of cache units 404 is illustrated. In the drawings described below, the DRAM 601, the plurality of flash memories 602, the CPU 66, the DRAM controller 67, and the SRAM 69 in each communication device 6 are not illustrated.

In the drawings described below, a request for a read operation, a request for a write operation, read data, and a write response are simply referred to as “read request”, “write request”, “read data”, and “write response”, respectively.

### 3.4.1.1 First Operation Example of Second Embodiment

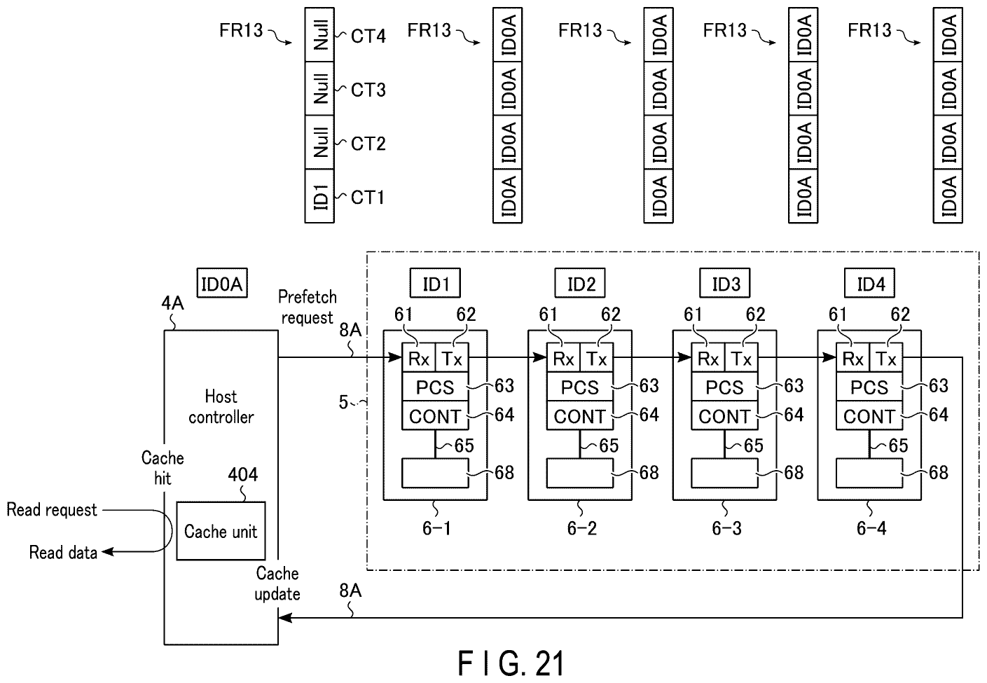

A first operation example of the communication system 1A according to the second embodiment will be described with reference to FIG. 21. FIG. 21 is a diagram illustrating the first operation example in the communication system according to the second embodiment. As the first operation example of the second embodiment, an example of a case in which a cache hit occurs for a read operation request received from an external apparatus will be described.

In the communication system 1A according to the second embodiment, the host controller 4A transmits the communication frame FR for requesting to read the prefetch data from the communication device 6 when a cache hit occurs for the read operation request. The prefetch data read from the communication device 6 is stored in the host controller 4A. Hereinafter, a request to read prefetch data from the communication device 6 will also be referred to as a prefetch request.

When the host controller 4A receives a read operation request from an external apparatus outside the communication system 1A, the cache controller 50 corresponding to the communication device 6 that is the target of the read operation determines whether the read data is stored in the cache memory 51. That is, the cache controller 50 determines whether a cache hit occurs for the read operation request. If the cache controller 50 determines that the cache hit has occurred for the read operation request, the cache controller 50 transmits the read data stored in the cache memory 51 to the external apparatus.

The cache controller 50 also estimates one or more pieces of prefetch data to be accessed after the read operation request based on the access pattern. The cache controller 50 also determines whether each of the one or more pieces of prefetch data is stored in the cache memory 51. When there is any prefetch data not stored in the cache memory 51, the communication control unit 44 inserts a command for requesting a read operation of one or more pieces of prefetch data not stored in the cache memory 51 into the container CT. The communication control unit 44 sets the transmission destination information of the container CT as identification information of the communication device 6 that stores the one or more pieces of prefetch data. The communication control unit 44 inserts the address of the one or more pieces of prefetch data into the packet payload PP of the container CT. The communication control unit 44 also inserts a read identifier into the container CT as the operation identifier of the read operation request of the prefetch data, for example. When there is no prefetch data not stored in the cache memory 51, the prefetch request is not executed.

In the first operation example of the second embodiment, it is determined that a cache hit has occurred for the read operation request received from an external apparatus. The read data stored in the cache memory 51 of the cache unit 404 is transmitted to the external apparatus. Then, a communication frame FR13, which includes a container CT1 into which the command for requesting the read operation of one or more pieces of prefetch data not stored in the cache memory 51 is inserted and containers CT2 to CT4 in the empty state, is transmitted from the host controller 4A to the communication device 6-1. In the first operation example of the second embodiment, one or more pieces of prefetch data are stored in the communication device 6-1. The packet payload PP of the container CT1 includes an address of one or more pieces of prefetch data in the communication device 6-1. In addition, a read identifier is inserted into the container CT1 as the operation identifier of a read operation request of prefetch data.

In the communication device 6-1, the communication control unit 64 inserts four pieces of prefetch data read by the communication device 6-1 into the containers CT1 to CT4 with the host controller 4A as a transmission destination. The communication control unit 64 also inserts a read identifier into the container CT as the operation identifier of the read operation request of the prefetch data, for example. In this manner, the communication frame FR13 is updated. The updated communication frame FR13 is transmitted from the communication device 6-1 to the communication device 6-2.

In the first operation example of the second embodiment, four pieces of prefetch data read by the communication device 6-1 are inserted into the containers CT1 to CT4, but the present invention is not limited to this example. The number of prefetch data estimated by the cache controller 50 may be one to three or five or more.

In the communication device 6-2 to 6-4, data extraction and updating of the communication frame FR13 are not executed. Accordingly, a communication frame FR13 equivalent to the communication frame FR13 transmitted from the communication device 6-1 is transmitted from the communication device 6-4 to the host controller 4A.

The communication frame FR13 transmitted from the communication device 6-4 includes containers CT1 to CT4 into which prefetch data is inserted. In this case, in the host controller 4A, the cache controller 50 updates the cache memory 51 using the prefetch data. The communication control unit 44 determines whether the prefetch data is inserted as packet (data) inserted into each container CT based on the operation identifier, for example. The cache controller 50 updates the cache memory 51 using the prefetch data.

This ends the processing of the first operation example of the second embodiment.

As described above, in a case where it is determined that a cache hit has occurred when there is a read operation request from an external apparatus to the communication system 1A, the read data stored in the cache unit 404 in the host controller 4A is transmitted to the external apparatus. The cache controller 50 updates the cache memory 51 using the prefetch data read from the communication device 6.

### 3.4.1.2 Second Operation Example of Second Embodiment

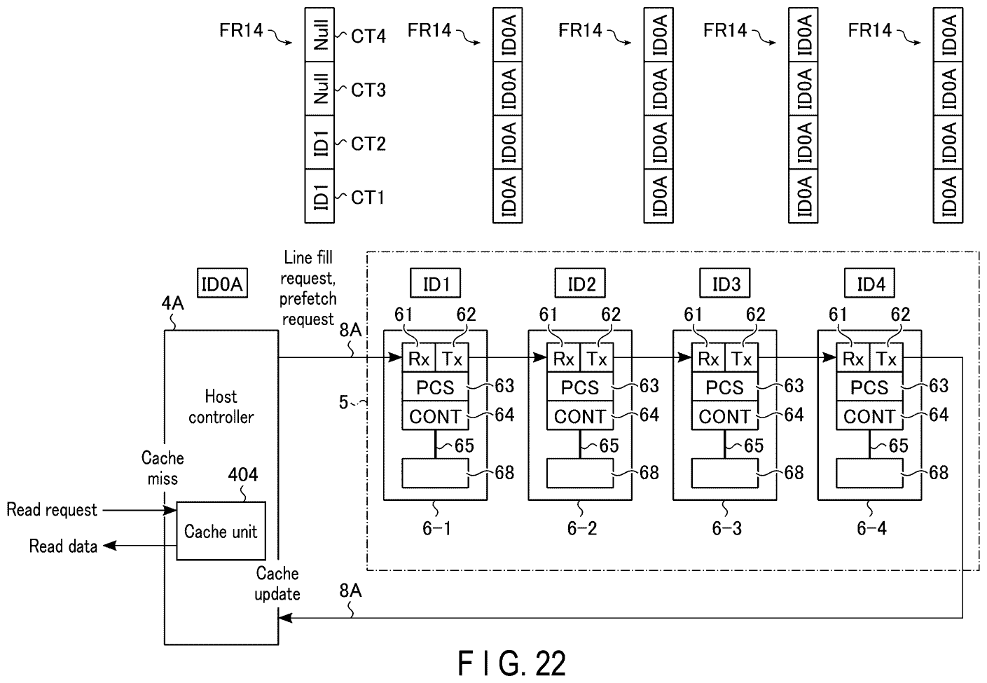

A second operation example of the communication system 1A according to the second embodiment will be described with reference to FIG. 22. FIG. 22 is a diagram illustrating the second operation example in the communication system according to the second embodiment. As the second operation example of the second embodiment, an example of a case in which a cache miss occurs for a read operation request received from an external apparatus will be described.

In the communication system 1A according to the second embodiment, the host controller 4A requests reading line fill data from the communication device 6 and reading prefetch data from the communication device 6 if a cache miss has occurred for a read operation request. In the second embodiment, the line fill data is read data that is read from the communication device 6 that stores data to be subjected to a read operation or a write operation when the cache controller 50 determines that a cache miss has occurred when there is a request for the read operation or the write operation. Then, the host controller 4A transmits the line fill data read from the communication device 6 to the external apparatus as read data. The line fill data and the prefetch data read from the communication device 6 are stored in the host controller 4A. Hereinafter, a request to read line fill data from the communication device 6 will also be referred to as a line fill request.

If the host controller 4A receives a read operation request from an external apparatus outside the communication system 1A and a cache miss occurs for the read operation request, the communication control unit 44 inserts a command for requesting a read operation of the line fill data into the container CT. The communication control unit 44 sets the transmission destination information of the container CT as identification information of the communication device 6 that stores the line fill data. The communication control unit 44 inserts the address of the line fill data into the packet payload PP of the container CT. The communication control unit 44 also inserts a read identifier into the container CT as the operation identifier of the read operation request of the line fill data. As in the first operation example of the second embodiment, estimation of prefetch data and a prefetch request are executed.

In the second operation example of the second embodiment, it is determined that a cache miss has occurred for the read operation request received from an external apparatus. Then, a communication frame FR14, which includes the container CT1 into which the command for requesting the read operation of the line fill data is inserted, the container CT2 into which the command for requesting the read operation of one or more pieces of prefetch data not stored in the cache memory 51 is inserted, and the containers CT3 and CT4 in the empty state, is transmitted from the host controller 4A to the communication device 6-1. In the second operation example of the second embodiment, the line fill data and the one or more pieces of prefetch data are stored in the communication device 6-1. The packet payload PP of the container CT1 includes an address of the line fill data in the communication device 6-1. In addition, a read identifier is inserted into the container CT1 as the operation identifier of the read operation request of the line fill data. The packet payload PP of the container CT2 includes addresses of one or more pieces of prefetch data in the communication device 6-1. In addition, a read identifier is inserted into the container CT2 as the operation identifier of the read operation request of prefetch data.

In the communication device 6-1, the communication control unit 64 inserts the line fill data and three pieces of prefetch data read from the communication device 6-1 into the containers CT1 to CT4 with the host controller 4A as a transmission destination. The communication control unit 64 also inserts a read identifier as the operation identifier of each of the line fill data and the three pieces of prefetch data into the container CT corresponding to each data. In this manner, the communication frame FR14 is updated. The updated communication frame FR14 is transmitted from the communication device 6-1 to the communication device 6-2.

In the communication device 6-2 to 6-4, data extraction and updating of the communication frame FR14 are not executed. Accordingly, a communication frame FR14 equivalent to the communication frame FR14 transmitted from the communication device 6-1 is transmitted from the communication device 6-4 to the host controller 4A.

In the host controller 4A that has received the communication frame FR transmitted from the communication device 6-4, if the container CT into which the line fill data is inserted is included in the communication frame FR, the host controller 4A transmits the line fill data to the external apparatus as read data in response to the read operation request. The communication control unit 44 determines whether the line fill data is inserted as packet (data) inserted into each container CT based on the operation identifier, for example. The cache controller 50 updates the cache memory 51 using the line fill data.

In the second operation example of the second embodiment, the line fill data read from the communication device 6-1 is transmitted to the external apparatus as read data. The cache controller 50 updates the cache memory 51 using the line fill data. As in the first operation example of the second embodiment, the cache controller 50 updates the cache memory 51 using the prefetch data.

This ends the processing of the second operation example of the second embodiment.

As described above, if it is determined a cache miss has occurred when there is a read operation request from an external apparatus to the communication system 1A, the line fill data read from the communication device 6 is transmitted to the external apparatus as read data. In addition, the cache memory 51 is updated using the line fill data and the prefetch data read from the communication device 6.

### 3.4.1.3 Third Operation Example of Second Embodiment

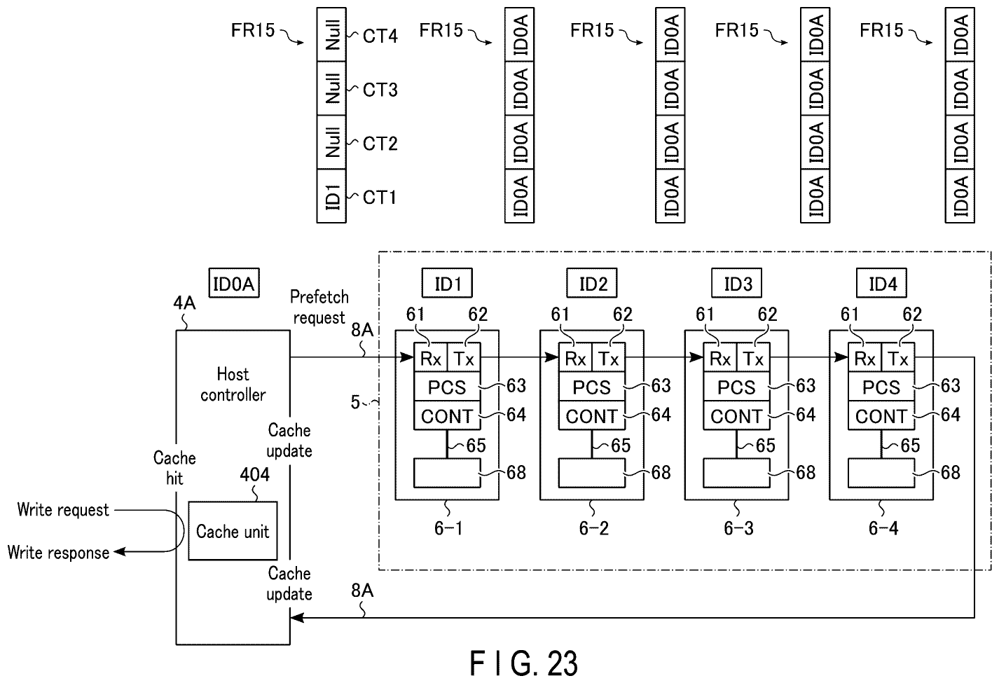

A third operation example of the communication system 1A according to the second embodiment will be described with reference to FIG. 23. FIG. 23 is a diagram illustrating the third operation example in the communication system according to the second embodiment. As the third operation example of the second embodiment, an example of a case where a cache hit occurs for a write operation request received from an external apparatus will be described.

In the communication system 1A according to the second embodiment, the host controller 4A requests to read the prefetch data from the communication device 6 when a cache hit has occurred for the write operation request. The prefetch data read from the communication device 6 is stored in the host controller 4A.

When the host controller 4A receives a write operation request from an external apparatus outside the communication system 1A, the host controller 4A transmits a write response to the external apparatus. The cache controller 50 corresponding to the communication device 6 that is the target of the write operation determines whether data corresponding to the write data is stored in the cache memory 51. That is, the cache controller 50 determines whether a cache hit occurs for the write operation request. If it is determined that a cache hit has occurred for the write operation request, the cache controller 50 updates the cache memory 51 based on the write operation request.

In the third operation example of the second embodiment, estimation of prefetch data and a prefetch request are executed as in the first operation example and the second operation example of the second embodiment. Accordingly, the communication system 1A is configured such that, for example, prefetch data estimated as data for which a read operation or a write operation can be requested is stored in advance in the cache memory 51 after processing is performed in response to a write operation request received from an external apparatus.

In the third operation example of the second embodiment, it is determined that a cache hit has occurred for the write operation request received from the external apparatus. The host controller 4A stores the received write operation request by updating the cache memory 51, for example. A write response to the write operation request is transmitted to the external apparatus. Then, a communication frame FR15, which includes a container CT1 into which the command for requesting the read operation of one or more pieces of prefetch data not stored in the cache memory 51 is inserted and containers CT2 to CT4 in the empty state, is transmitted from the host controller 4A to the communication device 6-1. In the third operation example of the second embodiment, one or more pieces of prefetch data are stored in the communication device 6-1. The packet payload PP of the container CT1 includes an address of one or more pieces of prefetch data in the communication device 6-1.

The operations on the communication frame FR15 by the communication devices 6-1 to 6-4 and the host controller 4A are similar to those on the communication frame FR13 in the first operation example of the second embodiment. Accordingly, in the third operation example of the second embodiment, the cache memory 51 is updated using the prefetch data read from the communication device 6-1.

The write data requested for the write operation by an external apparatus is written to the communication device 6 that is the target of the write operation by the write-back method after a write response is transmitted to the external apparatus, for example. In a write operation by the write-back method in the second embodiment, the communication control unit 44 inserts the write operation request stored in the cache memory 51 into the container CT to be transmitted to the communication device 6-1. The communication control unit 44 sets the transmission destination information of the container CT to the communication device 6 that is the target of the write operation. Accordingly, the write data is written to the communication device 6 that is the target of the write operation.

This ends the processing of the third operation example of the second embodiment.

As described above, if it is determined that a cache hit has occurred when there is a request for a write operation from an external apparatus to the communication system 1A, the cache memory 51 is updated using the write operation request. In addition, the cache memory 51 is updated using the prefetch data read from the communication device 6. The data that is the target of the write operation is written by the write-back method.

### 3.4.1.4 Fourth Operation Example of Second Embodiment

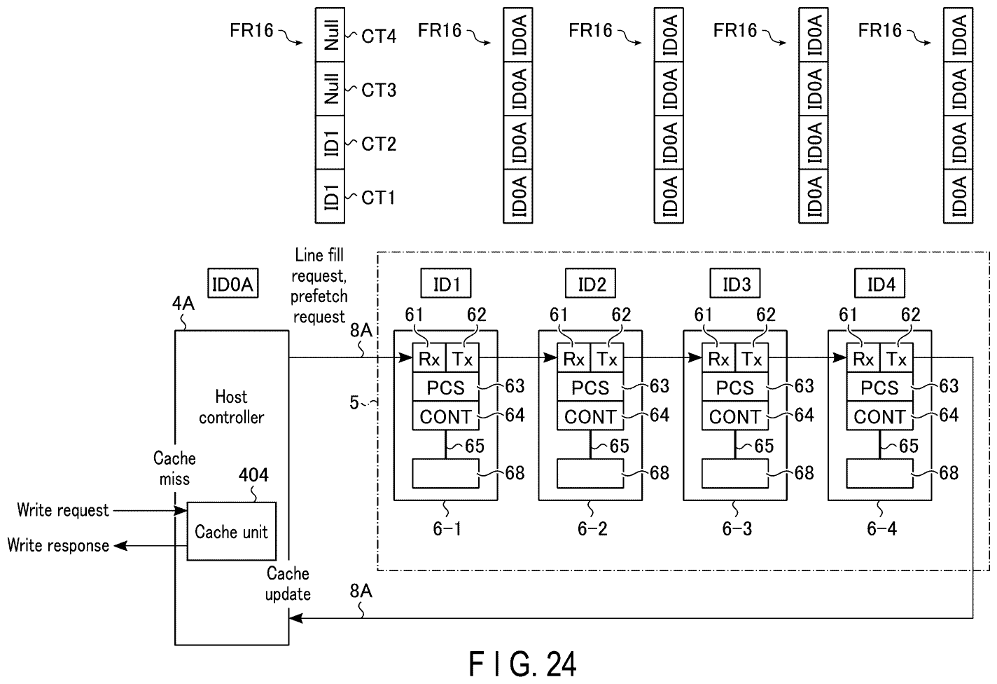

A fourth operation example of the communication system 1A according to the second embodiment will be described with reference to FIG. 24. FIG. 24 is a diagram illustrating the fourth operation example in the communication system according to the second embodiment. As the fourth operation example of the second embodiment, an example of a case in which a cache miss occurs for a write operation request received from an external apparatus will be described.

In the communication system 1A according to the second embodiment, the host controller 4A requests to read the line fill data and the prefetch data from the communication device 6 when a cache miss has occurred for the write operation request. The line fill data and the prefetch data read from the communication device 6 are stored in the host controller 4A.

When the host controller 4A receives a write operation request from an external apparatus outside the communication system 1A, if it is determined that a cache miss has occurred for the write operation request, the cache controller 50 executes a line fill request, estimation of prefetch data, and a prefetch request.

In the fourth operation example of the second embodiment, it is determined that a cache miss has occurred for the write operation request received from the external apparatus. A write response to the received write operation is transmitted to the external apparatus. Then, a communication frame FR16, which includes the container CT1 into which the command for requesting the read operation of the line fill data is inserted, the container CT2 into which the command for requesting the read operation of one or more pieces of prefetch data not stored in the cache memory 51 is inserted, and the containers CT3 and CT4 in the empty state, is transmitted from the host controller 4A to the communication device 6-1. In the fourth operation example of the second embodiment, the line fill data and the one or more pieces of prefetch data are stored in the communication device 6-1. The packet payload PP of the container CT2 includes addresses of one or more pieces of prefetch data in the communication device 6-1.

The operations on the communication frame FR16 in the communication device 6-1 to 6-4 are similar to those in the second operation example of the second embodiment.

If a cache miss has occurred for a write operation request, in the host controller 4A, the cache controller 50 overwrites the line fill data read from the communication device 6 based on the write operation request with write data that is the target of the write operation. Then, the cache controller 50 updates the cache memory 51 using the line fill data overwritten with the write data (write data after overwriting) and the read prefetch data.

In the fourth operation example of the second embodiment, the host controller 4A overwrites the line fill data read from the communication device 6-1 with the write data requested for the write operation by the external apparatus. In addition, the cache memory 51 is updated using the line fill data overwritten with the write data and the prefetch data read from the communication device 6-1. If it is determined that a cache miss has occurred for the write operation request, the write data is managed in the cache memory 51 by the write allocation method, for example. Accordingly, the write operation of the plurality of pieces of data with the size of the line L including the line fill data overwritten with the write data and the prefetch data is executed by the write-back method.

This ends the processing of the fourth operation example of the second embodiment.

As described above, if it is determined that a cache miss has occurred upon receipt of a write operation request from an external apparatus to the communication system 1A, the host controller 4A overwrites the line fill data read from the communication device 6 with write data that is the target of the write operation. In addition, the cache memory 51 is updated using the write data after overwriting and the prefetch data read from the communication device 6. The data that is the target of the write operation is written by the write-back method.

According to the configuration of the second embodiment, the host controller 4A includes the cache unit 404. Accordingly, when there is a request for an operation such as a read operation or a write operation from an external apparatus, the host controller 4A can execute a prefetch request so as to store, in the cache memory 51, prefetch data to be accessed after data that is the target of the operation. Therefore, the host controller 4A can store in advance the data requested to be operated in the cache memory 51. Even with such a configuration, it is possible to suppress an increase in latency as in the first embodiment and the modification of the first embodiment.

In addition, according to the second embodiment, since the prefetch data can be stored in the cache memory 51 in advance as described above, it is possible to suppress exhaustion of outstanding numbers if access of a small data size such as a read operation or a write operation frequently occurs.

According to the second embodiment, it is possible to reduce the overhead as compared with a comparative example in which every time there is a request for a read operation or a write operation of one piece of data, a container including the operation request is transmitted to a communication device. As a supplementary explanation, in the comparative example, in a case of reading a plurality of pieces of data from the communication device, for example, the number of containers to be transmitted for requesting the read operation increases according to the number of pieces of read data. On the other hand, according to the second embodiment, a plurality of pieces of prefetch data can be read from the communication device 6 by transmitting the communication frame FR including one container CT into which a command for requesting a read operation of the prefetch data is inserted. That is, according to the second embodiment, it is possible to reduce the number of containers CT transmitted for reading a plurality of pieces of data as compared with the comparative example. As a result, according to the second embodiment, the overhead can be reduced. In addition, the efficiency of bandwidth use can be improved.

It is also possible to suppress an increase in latency by a configuration in which the number of pieces of prefetch data stored in the cache memory 51 is determined according to the length of the communication paths 8A or the number of communication devices 6. 4 Others

In the first embodiment, the modification of the first embodiment, and the second embodiment described above, the communication devices 6 are memory devices including a NAND flash memory. However, the communication devices 6 are not limited to memory devices. The plurality of communication devices 6 mounted on one device board 5 may be mutually different devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising:
a host controller;
a plurality of communication devices;
a cache device; and
a communication path that couples the host controller and the cache device and couples the cache device and the communication devices in a ring shape, and is capable of transmitting a communication frame of a serial signal having a plurality of containers, wherein
the cache device includes:
a first reception circuit configured to receive a first communication frame from the host controller, via the communication path;
a first control circuit capable of data insertion and extraction into and from at least one of a plurality of containers included in the received first communication frame;
a first transmission circuit configured to transmit a second communication frame based on a processing result of the first control circuit to a first communication device that is coupled to the cache device among the communication devices, via the communication path;
a second reception circuit configured to receive a third communication frame from a second communication device that is different from the first communication device among the communication devices and is coupled to the cache device, via the communication path;
a second control circuit capable of data insertion and extraction into and from at least one of a plurality of containers included in the received third communication frame;
a second transmission circuit configured to transmit a fourth communication frame based on a processing result by the second control circuit to the host controller, via the communication path;
a memory configured to store data received from the second communication device by at least the third communication frame; and
a controller that is coupled to the first control circuit and the second control circuit and configured to control the memory.

2. The communication system according to claim 1, wherein
when the first reception circuit receives, as the first communication frame, a fifth communication frame including a first container into which a request for a read operation of first data from any of the communication devices is inserted,
if the memory stores the first data,
the second control circuit is configured to insert the stored first data into a second container of a sixth communication frame received by the second reception circuit, and
if the memory does not store the first data,
the first control circuit is configured to insert a request for a read operation of the first data into a third container of a seventh communication frame received by the first reception circuit.

3. The communication system according to claim 2, wherein
if the memory is in a cache-full state with no free space to store data,
the controller is configured to erase second data from the memory before inserting the request for the read operation of the first data into the third container.

4. The communication system according to claim 3, wherein
the memory includes a plurality of lines each including data and first information related to a state of the data, and
when erasing the second data from the memory,
the first control circuit is further configured to insert a request for a write operation of the second data to any of the communication devices into a fourth container of an eighth communication frame received by the first reception circuit based on the first information included in a line including the second data among the lines.

5. The communication system according to claim 1, wherein
when the first reception circuit receives, as the first communication frame, a fifth communication frame including a first container into which a request for a write operation of first data to any of the communication devices is inserted,
the controller is configured to execute a write operation using the first data by a write-back method.

6. The communication system according to claim 5, wherein
when the first reception circuit receives the fifth communication frame,
if the memory does not store data corresponding to the first data, and the memory is in a cache-full state with no free space to store data,
the controller is further configured to update the memory using the first data after erasing the second data from the memory.

7. The communication system according to claim 1, wherein
if the memory is in a cache-full state with no free space to store data, or is close to the cache-full state,
the controller is configured to erase the first data stored in the memory from the memory.

8. The communication system according to claim 1, wherein
the host controller is capable of transmitting a first container into which a command for erasing data stored in the memory is inserted, and
based on reception of the first container by the first reception circuit,
the controller is configured to erase first data from the memory.

9. The communication system according to claim 1, wherein
the first control circuit is configured to perform processing on each of the containers based on an identifier inserted into each of the containers.

10. The communication system according to claim 1, wherein
the second control circuit is configured to:
determine whether data inserted into each of the containers is data related to an operation requested by the host controller or data related to an operation requested by the cache device based on an identifier inserted into each of the containers, and
perform processing on each of the containers based on a result of the determination.

11. A communication system comprising:
a host controller;
a plurality of first communication devices; and
a first communication path that couples the host controller and the first communication devices in a ring shape and is capable of transmitting a communication frame of a serial signal having a plurality of containers, wherein
the host controller includes:
a first reception circuit configured to receive a first communication frame from a second communication device that is coupled to the host controller among the first communication devices, via the first communication path;
a first control circuit capable of data insertion and extraction into and from at least one of a plurality of containers included in the received first communication frame;
a first transmission circuit configured to transmit a second communication frame based on a processing result of the first control circuit to a third communication device that is different from the second communication device among the first communication devices and is coupled to the host controller, via the first communication path; and
a first cache unit having a first memory configured to store at least data received from the second communication device by the first communication frame, wherein
when the host controller receives, from an outside, a request for a first operation related to first data stored in any of the first communication devices,
the first cache unit is configured to
estimate second data that is a target of a request for a read operation from the outside after the first operation, and
the first control circuit is configured to
insert a request for a read operation of the second data to any communication device storing the second data among the first communication devices, into a first container included in a third communication frame to be transmitted to the third communication device.

12. The communication system according to claim 11, further comprising:
a plurality of fourth communication devices; and
a second communication path that couples the host controller and the fourth communication devices in a ring shape and is capable of transmitting a communication frame of a serial signal having a plurality of containers, wherein
the host controller further includes:
a second reception circuit configured to receive a fourth communication frame from a fifth communication device that is coupled to the host controller among the fourth communication devices, via the second communication path;
a second control circuit capable of data insertion and extraction into and from at least one of a plurality of containers included in the received fourth communication frame;
a second transmission circuit configured to transmit a fifth communication frame based on a processing result of the second control circuit to a sixth communication device that is different from the fifth communication device among the fourth communication devices and is coupled to the host controller, via the second communication path; and
a second cache unit having a second memory configured to store at least data received from the fifth communication device by the fifth communication frame, wherein
when the host controller receives, from the outside, a request for a second operation related to third data stored in any of the fourth communication devices,
the second cache unit is configured to
estimate fourth data that is a target of a request for a read operation from the outside after the second operation, and
the second control circuit is configured to
insert a request for a read operation of the fourth data to any communication device storing the fourth data among the fourth communication devices, into a second container included in a sixth communication frame to be transmitted to the sixth communication device.

13. The communication system according to claim 11, wherein
when the host controller receives, from the outside, a request for a read operation of the first data to any of the first communication devices as the request for the first operation, if the first memory stores the first data, the first cache unit is configured to
transmit the first data stored in the first memory to the outside.

14. The communication system according to claim 13, wherein
the first cache unit is configured to
update the first memory using data read from any of the first communication devices based on a request for a read operation of the second data inserted into the first container.

15. The communication system according to claim 11, wherein
when the host controller receives the request for the first operation from the outside, if the first memory does not store the first data,
the first control circuit is configured to
insert a request for a read operation of the first data to a communication device storing the first data among the first communication devices, into a second container included in a fourth communication frame to be transmitted to the third communication device.

16. The communication system according to claim 15, wherein
the first cache unit is configured to
update the first memory using data read from any of the first communication devices based on the request for the read operation of the first data inserted into the second container and the request for the read operation of the second data inserted into the first container.

17. The communication system according to claim 16, wherein
when the host controller receives, from the outside, a request for a write operation of the first data to any of the first communication devices as the request for the first operation, the first cache unit is configured to
overwrite data read from any of the first communication devices based on the request for the read operation of the first data inserted into the second container, with the first data that is the target of the request for the write operation from the outside, and update the first memory using the overwritten data.

18. The communication system according to claim 11, wherein
when the host controller receives, from the outside, a request for a write operation of the first data to any of the first communication devices as the request for the first operation, if the first memory stores the first data, the first cache unit is configured to
transmit a first response to the request for the write operation to the outside.

19. The communication system according to claim 18, wherein
after the first cache unit transmits the first response to the outside, the first control circuit
inserts a request for a write operation of the first data to any of the first communication devices, into a second container included in a fourth communication frame to be transmitted to the third communication device.

20. The communication system according to claim 11, wherein
the first control circuit is configured to perform processing on each of the containers based on an identifier inserted into each of the containers.
